(19) United States
(12) Patent Application Publication
(10) Pub. No.: US 2010/0060960 A1
(43) Pub. Date: Mar. 11, 2010

(54) REPRODUCTION DEVICE AND REPRODUCTION METHOD

(75) Inventors: Kenji Tanaka, Tokyo (JP); Koji Takasaki, Chiba (JP); Kazutatsu Tokuyama, Tokyo (JP); Atsushi Fukumoto, Kanagawa (JP); Hidenori Mori, Kanagawa (JP); Yoshiki Okamoto, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: Sony Corporation, Tokyo (JP)

(21) Appl. No.: 12/538,318

(22) Filed: Aug. 10, 2009

(30) Foreign Application Priority Data
Sep. 9, 2008 (JP) 2008-231362

(51) Int. Cl. G03H 1/12; G03H 1/22; G03H 1/14

(52) U.S. Cl. 359/11; 359/32

(57) ABSTRACT

A reproduction device includes a light-emitting unit that emits reference light and coherent light, which is generated so as to have uniform light intensity and uniform phase, onto a hologram recording medium on which data is recorded by an interference pattern of signal light and the reference light, and a light-attenuating unit that attenuates the light intensity of the coherent light.

### BACKGROUND OF THE INVENTION

1. Field of the Invention

The present invention relates to a reproduction device that performs reproduction with respect to a hologram recording medium on which data is recorded by an interference pattern of reference light and signal light, and to a reproduction method for performing such reproduction.

2. Description of the Related Art

Japanese Unexamined Patent Application Publication Nos. 2006-107663 and 2007-79438 describe examples of a hologram recording/reproduction method for recording data by forming a hologram with an interference pattern of signal light and reference light and reproducing the data, recorded based on the hologram defined by the interference pattern, by emitting the reference light. One example of such a hologram recording/reproduction method is a so-called coaxial method in which recording is performed by disposing the signal light and the reference light coaxially with each other.

FIG. 17 and FIGS. 18A and 18B illustrate how hologram recording/reproduction is performed based on a coaxial method. Specifically, FIG. 17 illustrates how recording is performed, whereas FIGS. 18A and 18B illustrate how reproduction is performed.

Referring to FIG. 17, when recording, a spatial light modulator (SLM) 101 performs spatial light intensity modulation (also referred to as “light intensity modulation” or simply as “intensity modulation”) on incident light from a light source so as to generate signal light and reference light disposed coaxially with each other. The SLM 101 may be formed of, for example, a liquid crystal panel that transmits or blocks incident light with respect to each pixel.

In this case, the signal light is generated so as to be given an intensity pattern according to recording data. On the other hand, the reference light is generated so as to be given a predetermined intensity pattern.

The signal light and the reference light generated by the SLM 101 in this manner enter a phase mask 102. The phase mask 102 gives a random phase modulation pattern to the signal light and the reference light, as shown in FIG. 17.

The reason for giving such a random phase modulation pattern to the signal light and the reference light is to enhance the interference efficiency of the signal light and the reference light and to minimize a DC component by diffusing the spectrum of the signal light and the reference light in order to achieve a high recording density.

As an example of a specific phase modulation pattern for minimizing a DC component, a random pattern with two values “0” and “π” is set. Specifically, a random phase modulation pattern with a fifty-fifty mixture of pixels not subject to phase modulation (i.e., phase=0) and pixels whose phase is to be modulated by π (180°) is set.

As a result of the light intensity modulation performed by the SLM 101, the signal light is generated such that the light intensity thereof is modulated to “0” or “1” depending on the recording data. By performing phase modulation by “0” or “π” on the signal light, light having a wavefront amplitude of “−1”, “0”, or “1(+1)” is generated. Specifically, when phase “0” modulation is performed with respect to a pixel modulated based on the light intensity “1”, the amplitude is “1”. In the case of phase “π” modulation, the amplitude is “−1”. With respect to a pixel with a light intensity “0”, the amplitude remains “0” whether the modulation is performed based on the phase “0” or “π”.

For confirmation, FIGS. 19A and 19B illustrate how the signal light and the reference light are different between the absence (FIG. 19A) and the presence (FIG. 19B) of the phase mask 102. FIGS. 19A and 19B express the magnitude relationship in the amplitude of light using color densities. In FIG. 19A, the black and white colors respectively represent the amplitudes “0” and “1”. In FIG. 19B, the black, grey, and white colors respectively represent the amplitudes “−1”, “0”, and “1(+1)”.

The phase modulation pattern according to the phase mask 102 is a random pattern. Thus, the pixels with the light intensity “1” within the signal light output from the SLM 101 can be randomly divided into a fifty-fifty mixture of amplitudes “1” and “−1”. By randomly dividing the pixels into amplitudes “1” and “−1”, the spectrum can be evenly spread over a Fourier plane (i.e., a frequency plane: an image on the medium in this case), thereby minimizing the DC component in the signal light. Furthermore, with the phase mask 102, the DC component in the reference light can also be minimized, thereby preventing a DC component from being generated in the Fourier plane.

By minimizing the DC component in this manner, the data recording density can be enhanced. The reason for this is that, when a DC component is generated, the recording material significantly responds to the DC component, making it difficult to perform multiplex hologram recording. In other words, it becomes difficult to further perform multiplex recording of a hologram (data) on a section where a DC component is already recorded.

Minimizing the DC component using the above-described random phase pattern allows for multiplex data recording, thereby achieving high recording density.

The signal light and the reference light passing through the phase mask 102 are both focused by an objective lens 103 and are emitted to a hologram recording medium HM. In consequence, an interference pattern (diffraction grating: hologram) according to the signal light (recording image) is formed on the hologram recording medium HM. In other words, data is recorded as the result of the formation of the interference pattern.

Referring to FIG. 18A, when performing reproduction, the SLM 101 performs spatial light modulation (intensity modulation) on incident light so as to generate reference light. The reference light generated in this manner travels through the phase mask 102 and then the objective lens 103 so as to be emitted to the hologram recording medium HM.

By emitting the reference light to the hologram recording medium HM in this manner, diffracted light according to the recorded hologram is obtained, as shown in FIG. 18B, and is output as reflected light from the hologram recording medium HM. In other words, a reproduction image (i.e., reproduction light) according to the recorded data is obtained.

The reproduction image obtained in this manner is optically received by an image sensor 104, such as a charge-coupled-device (CCD) sensor or a complementary metal oxide semiconductor (CMOS) sensor. Based on the received signal of the image sensor 104, the recorded data is reproduced.

In a hologram recording/reproduction system, recording is performed while performing phase modulation by “0” or “π” on signal light containing intensity information according to the recording data so as the minimize the DC component, thereby allowing for multiplex hologram recording.

When such phase modulation recording is performed, the signal light contains three values “0”, “+1”, and “−1” as amplitude information, as shown in FIG. 19B. In other words, these three values are recorded onto the hologram recording medium HM.

However, the problem in this case is that the image sensor 104, which detects a reproduction image during reproduction, is only capable of detecting information about the light intensity.

An optical system in a hologram recording/reproduction system is generally configured based on a 4f optical system in which an SLM, an objective lens, a medium, an ocular lens (objective lens), and an image sensor are arranged such that they are spaced apart from each other by a focal length of a lens. This configuration is a so-called Fourier-transform hologram configuration.

In such a Fourier-transform hologram configuration, the series of steps described above for recording/reproduction can be considered as follows. Specifically, a recording data pattern of the SLM is Fourier-transformed and projected onto the hologram recording medium, whereas a readout signal (reproduction image) of the medium is inversely Fourier-transformed and projected onto the image sensor. The image sensor detects a light intensity value which is a square of an absolute value of the wavefront amplitude of the light incident on the image sensor.

In view of this point, the hologram recording/reproduction system of the related art has nonlinear characteristics since it is capable of recording both the intensity and the phase but can only reproduce information about the intensity. Due to such a problem regarding nonlinear characteristics in the hologram recording/reproduction system of the related art, it is extremely difficult to properly reproduce data after phase modulation recording.

In order to solve such a problem regarding nonlinear characteristics, the present applicant has proposed a technology for achieving linear reading that allows for proper reading of phase information recorded on a medium (i.e., phase “−1” information in this case). In detail this reading method is a so-called “coherent addition method” discussed in Japanese Unexamined Patent Application Publication No. 2008-1528287.

In this coherent addition method, when performing reproduction, coherent light, as shown in FIG. 20, is generated and is emitted to the hologram recording medium HM together with the reference light. In other words, in contrast to the normal reproduction method described above with reference to FIGS. 18A and 18B in which only the reference light is emitted to obtain a reproduction image, the coherent light is additionally emitted in the coherent addition method.

The coherent light is generated so as to have uniform light intensity and uniform phase. Furthermore, in a coaxial method, the coherent light is generated by allowing light to be transmitted through the same area as the area where the signal light is generated (referred to as “signal-light area”) for recording, as shown in FIG. 20.

A reproduction technique based on the coherent addition method will be described in detail with reference to FIGS. 21A and 21B.

First, when performing reproduction based on the coherent addition method, a phase modulator (i.e., a phase modulator 101b in FIG. 21A) that can variably perform phase modulation is provided as a phase modulation element. In this case, in a hologram recording/reproduction system that performs reproduction based on the coherent addition method, it may be necessary to set a phase pattern that allows for the aforementioned multiplex recording for the recording mode (i.e., a binary random phase pattern corresponding to the phase mask 102) and a uniform phase pattern for generating coherent light for the reproduction mode as phase patterns to be given to the incident light. In other words, the phase modulator 101b that can variably perform phase modulation is preferably used as a phase modulation element.

In this case, the SLM 101 is integrally provided with an intensity modulator 101a that performs intensity modulation with respect to incident light and the aforementioned phase modulator 101b. With such an SLM 101, the intensity and the phase of the incident light can be modulated in a freely chosen manner.

As shown in FIG. 21A, when performing reproduction, the SLM 101 generates reference light and coherent light.

In the reproduction mode, reference light having the same intensity pattern and the same phase pattern as in the recording mode is generated. In other words, the reference light to be generated has the same intensity pattern and the same phase pattern as those of the reference light generated when recording a hologram, which is to become a reproduction object. This is because, in order to properly reproduce a multiplex-recorded hologram, it may be necessary to emit reference light with the same patterns as the patterns used for recording the hologram. In other words, a hologram recorded by emitting reference light having a certain pattern can be properly reproduced only by using reference light having the same pattern.

In consequence, the reference light generated in the reproduction mode has the same intensity pattern and the same phase pattern as those of the reference light used in the recording mode.

As mentioned above, the coherent light is generated by allowing light to be transmitted through the area where the signal light is generated (i.e., the signal-light area) for recording. Specifically, the coherent light is generated such that the intensity thereof is made uniform by causing the intensity modulator 101a to modulate the individual pixels within the signal-light area to a predetermined intensity.

In the coherent addition method, the coherent light having uniform intensity and a reproduction image obtained as a result of the emission of the reference light both form respective images on the image sensor 104, and the image sensor 104 detects combined light of the reproduction image and the coherent light.

In this case, the coherent light is added as a component with the same phase as that of the reproduction image. Therefore, the phase of the coherent light is set equal to the phase of the reproduction image (i.e., a reference phase in the reproduction image).

The term “reference phase in the reproduction image” refers to the phase of recorded pixels modulated by phase “0” (0π) out of images (recording signals) of the individual pixels, included in the reproduction image, of the SLM 101.

The reference phase in the reproduction image corresponds to the phase of recorded signals given On-phase modulation by the phase modulator 101b. Therefore, in order to allow the phase of the coherent light to be in accord with the reference phase in the reproduction image, it can be considered that phase modulation by phase “0” may be given to the coherent light by the phase modulator 101b.

However, in a hologram recording/reproduction system, it may be necessary to take into consideration that the phase of a reproduction image obtained by emitting reference light to the hologram recording medium HM is deviated by π/2 from the phase of a signal recorded on the medium. In other words, if phase “0” modulation is given to the coherent light, a phase difference of π/2 occurs between the reference phase in the reproduction image and the phase of the coherent light, making it difficult to properly add the coherent light as a component having the same phase as that of the reproduction image.

In view of this point, in order to allow the phase of the coherent light to be in accord with the reference phase in the reproduction image, the phase modulator 101b performs phase modulation by π/2. Specifically, the phase modulator 101b in this case performs phase modulation by π/2 with respect to each pixel in the signal-light area.

As the reference light and the coherent light are generated as the result of the spatial light modulation performed by the SLM 101, the reproduction image and the coherent light having the same phase as the reproduction image are guided to the image sensor 104 via the objective lens 103, as shown in FIG. 21B. In this case, the coherent light is detected by the image sensor 104 as an added component having the same phase as the reproduction image.

In the coherent addition method, such components of “reproduction image+coherent light” are detected by the image sensor 104, and a linear readout signal is obtained by processing the detected image signal of “reproduction image+coherent light” in the following manner.

First, with respect to the image signal of “reproduction image+coherent light”, the square root of each pixel value is calculated.

Then, the added coherent-light component is removed from the square-root calculation result. Specifically, for example, the intensity value of the added coherent light is subtracted from the value of the square-root calculation result.

The following description relates to how linear reading is achieved by the series of the aforementioned steps, namely, the coherent-light addition step, the square-root calculation step, and the added-component removal step.

In the following description, the amplitude of the reproduction image is within a range of ±0.078. In other words, the maximum amplitude value of the reproduction image is 0.078, whereas the minimum amplitude value thereof is −0.078.

Furthermore, the intensity value of the added coherent light is, for example, 0.1.

First, a comparison example in which reading is performed by only emitting reference light and not performing coherent addition will be discussed.

According to the above-described Fourier-transform hologram and the maximum and minimum amplitude values of the reproduction image, an output value of the image sensor 104 obtained in accordance with the maximum and minimum amplitude values of the reproduction image is obtained as the same value of “6.1E-3” which is a square thereof. Since the values corresponding to “+1” and “−1” are detected as the same value by the image sensor 104, it becomes difficult to properly restore lost phase information whether any kind of signal processing is performed thereafter. In other words, nonlinear distortion occurs.

On the other hand, when coherent light with the same phase as that of the reproduction image is emitted together with the reference light according to the coherent addition method, a value according to the intensity of the coherent light can be added to the reproduction image. For confirmation, since such coherent light has a DC component with uniform amplitude and uniform phase, the coherent light substantially does not interfere with the recorded hologram.

According to the above description, the added amount of coherent light in this case is, for example, 0.1. Thus, a component of 0.1 is added to the reproduction image so that the image sensor 104 detects an intensity of 0.178²=0.032 for the maximum value 0.078 and an intensity of 0.022²=4.8E-4 for the minimum value −0.078. In this case, a square-root value is calculated, as mentioned above, with respect to the output of the image sensor 104, and the added component is subsequently removed. Thus, the maximum amplitude value 0.078 can be restored to its original value by 0.178−0.1=0.078, and the minimum amplitude value −0.078 can be restored to its original value by 0.022−0.1=−0.078.

Such a reproduction technique based on the coherent addition method allows for linear reading in which phase information recorded by phase modulation recording is not lost.

An important point in this case is the added amount (intensity value) of coherent light with respect to the reproduction image. Specifically, in order to achieve the aforementioned linear reading, it is desirable that the condition “the added amount of coherent light is greater than an absolute value of the minimum amplitude value of the reproduction image” is at least satisfied to prevent the intensity value (square value) detected by the image sensor 104 from being inverted to a negative value.

In view of this point, in the coherent addition method, it is desirable that the coherent light, when added to the reproduction image, at least satisfies the condition “the intensity thereof is greater than an absolute value of the minimum amplitude value of the reproduction image” and the condition “the phase thereof is the same as the reference phase of the reproduction image”.

### SUMMARY OF THE INVENTION

According to the coherent addition method, when three amplitude values “−1”, “0”, and “+1” are to be recorded to minimize a DC component by phase modulation recording in order to achieve high recording density, the values “−1” and “+1” including phase information can be properly read out together with the phase “0”, thereby achieving linear reading.

However, the coherent addition method of the related art is problematic in that it does not take into consideration the intensity difference between the reproduction image and the coherent light.

The reproduction image is obtained based on a diffraction phenomenon occurring in accordance with the emission of reference light to a hologram recorded on the hologram recording medium HM. In other words, the light intensity of the reproduction image is dependent on the diffraction efficiency in such a diffraction phenomenon.

In detail, a diffraction efficiency η in a hologram recording/reproduction system is generally about 10⁻³ to 10⁻⁴.

On the other hand, the intensity of coherent light to be added to the reproduction image is determined only on the basis of the amount of loss of light that occurs while the light output from the intensity modulator 101a is guided to the image sensor 104 via the hologram recording medium HM. In other words, since the coherent light simply does not experience such a loss in the amount of light by the aforementioned diffraction efficiency, the coherent light apparently has an extremely high intensity as compared with the intensity of the reproduction image.

In detail, supposing that the intensity of coherent light is set as “1”, a phase I detected by the image sensor 104 (both the phase of pixels on which phase “1” is recorded and the phase of pixels on which phase “−1” is recorded) can be expressed as follows:

I=(1±\sqrt{η})² (1)

In this case, if the diffraction efficiency η is equal to 10⁻⁴, the phase I is expressed as follows:

I=(1±\sqrt{10⁻⁴})²=(1±10⁻²)²=1.02 0.98 (2)

This means that the contrast of the reproduction image is extremely low (phase “1” to phase “−1”) relative to the intensity of coherent light, which is to serve as background light. In this case, it may be necessary to detect a slight intensity difference of 2%.

It is extremely difficult to accurately detect such a reproduction image having a low contrast. For this reason, in the related art, deterioration in the reproduction characteristics is unavoidable.

Although Japanese Unexamined Patent Application Publication No. 2008-152827 discloses an example where the intensity of coherent light is set to “0.1” instead of “1”, there still exists a problem in the related art in that the intensity adjustment of the coherent light is performed by using an intensity modulator that variably performs light intensity modulation with respect to individual pixels.

In view of the aforementioned diffraction efficiency (e.g., 10⁻⁴), it is desirable that the intensity of coherent light to be added be reduced to, for example, about 0.1% ( 1/1000) when intensity “1” modulation is performed.

However, under the present circumstances, in a configuration in which light intensity modulation is variably performed with respect to individual pixels, it is extremely difficult to stably set the intensity to about 1/1000. For this reason, in the related art, the intensity (amplitude) of coherent light is set significantly greater than the amplitude of the reproduction image, such as “1” or “0.1”, leading to deterioration in reproduction characteristics.

According to an embodiment of the present invention, there is provided a reproduction device that includes a light-emitting unit that emits reference light and coherent light, which is generated so as to have uniform light intensity and uniform phase, onto a hologram recording medium on which data is recorded by an interference pattern of signal light and the reference light, and a light-attenuating unit that attenuates the light intensity of the coherent light.

In the configuration according to the embodiment of the present invention in which the coherent light is generated and emitted in the reproduction mode, a unit for attenuating the light intensity of the coherent light is additionally provided. This allows the intensity of coherent light to be attenuated significantly.

According to the embodiment of the present invention, because the light-attenuating unit for attenuating the light intensity of coherent light is additionally provided, the intensity of coherent light can be attenuated significantly. Thus, the contrast of a reproduction image obtained by the emission of reference light can be relatively increased, thereby improving the reproduction characteristics.

### BRIEF DESCRIPTION OF THE DRAWINGS

FIG. 1 is a block diagram illustrating the internal configuration of a recording/reproduction device according to a first embodiment;

FIGS. 2A and 2B illustrate how intensity modulation is performed by a combination of a polarization-direction control type spatial light modulator and a polarization beam splitter;

FIG. 3 illustrates a reference-light area, a signal-light area, and a gap area set in the spatial light modulator;

FIGS. 4A and 4B illustrate the structure of a phase modulator that can variably perform spatial light phase modulation with respect to individual pixels;

FIG. 5 illustrates the internal configuration of a spatial-light-modulation control unit;

FIG. 6 illustrates the internal configuration of a data reproducing unit;

FIG. 7 illustrates the structure of a partial light-attenuating element according to an embodiment;

FIGS. 8A and 8B illustrate a light-attenuating technique according to the first embodiment;

FIG. 9 is a block diagram illustrating the internal configuration of a recording/reproduction device according to a first example of a second embodiment;

FIG. 10 illustrates the structure of a partial polarization-direction controlling element according to the first example of the second embodiment;

FIG. 11 illustrates the relationship between an angle formed between a reference optical axis of a phase shifter and a polarization-direction axis of incident light and the transmittance of the polarization beam splitter;

FIG. 12 is a block diagram illustrating the internal configuration of a recording/reproduction device according to a second example of the second embodiment;

FIGS. 13A and 13B illustrate a light-attenuating technique according to the second example of the second embodiment;

FIG. 14 is a block diagram illustrating the internal configuration of a recording/reproduction device according to a third embodiment;

FIG. 15 illustrates the structure of a partial polarization-direction controller included in the recording/reproduction device according to the third embodiment;

FIG. 16 illustrates a configuration example of a recording/reproduction device to which a real image plane of a spatial light modulator is added;

FIG. 17 illustrates how a hologram recording/reproduction method is performed based on a coaxial method during recording;

FIGS. 18A and 18B illustrate how the hologram recording/reproduction method is performed based on the coaxial method during reproduction;

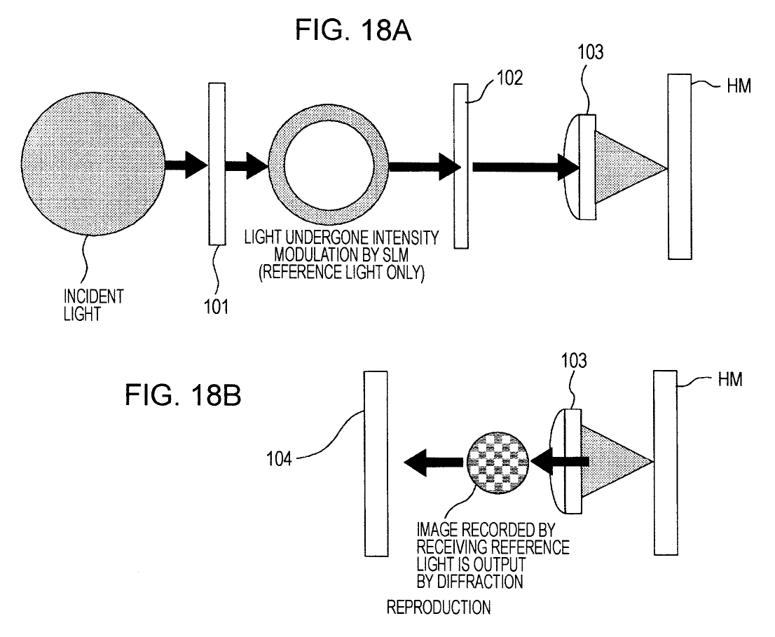

FIGS. 19A and 19B are diagrams comparing the amplitudes of signal light and reference light based on the presence and absence of a phase mask;

FIG. 20 is a diagram for explaining coherent light; and

FIGS. 21A and 21B are diagrams for explaining a coherent addition method.

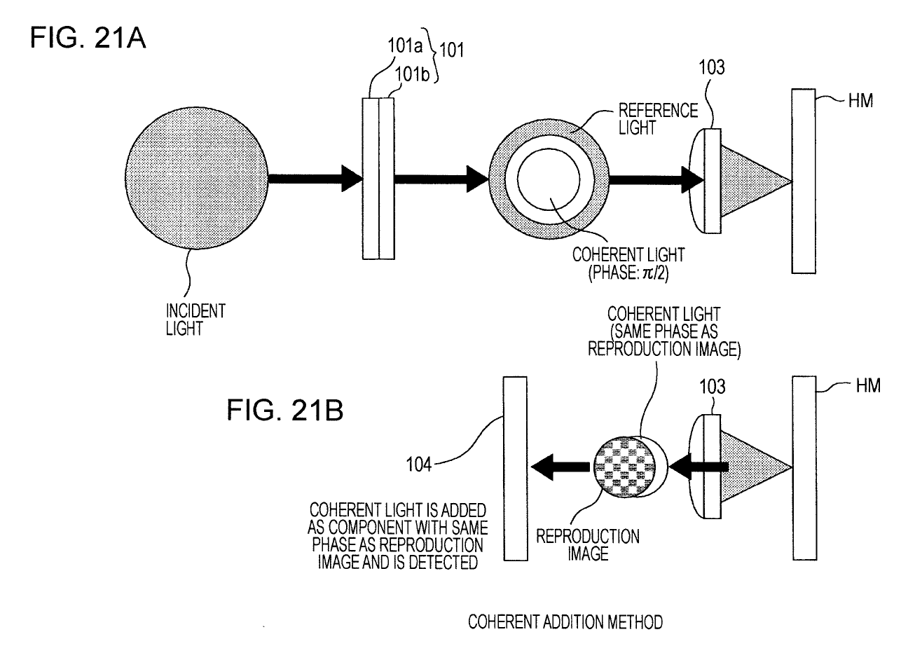

### DESCRIPTION OF THE PREFERRED EMBODIMENTS

Preferred embodiments of the present invention will be described below in the following order.

1. First Embodiment (Example that uses Partial Light-Attenuating Element)
Configuration of Recording/Reproduction Device
Partial Light-Attenuating Technique according to First Embodiment

2. Second Embodiment (Example that uses Partial Polarization-Direction Controlling Element)
2.1. First Example (Slidably-Driving Partial Polarization-Direction Controlling Element)
2.2. Second Example (Rotatably-Driving Partial Polarization-Direction Controlling Element)

3. Third Embodiment (Example that uses Partial Polarization-Direction Controller)
4. Modifications

### 1. FIRST EMBODIMENT (EXAMPLE THAT USES PARTIAL LIGHT-ATTENUATING ELEMENT)

Configuration of Recording/Reproduction Device

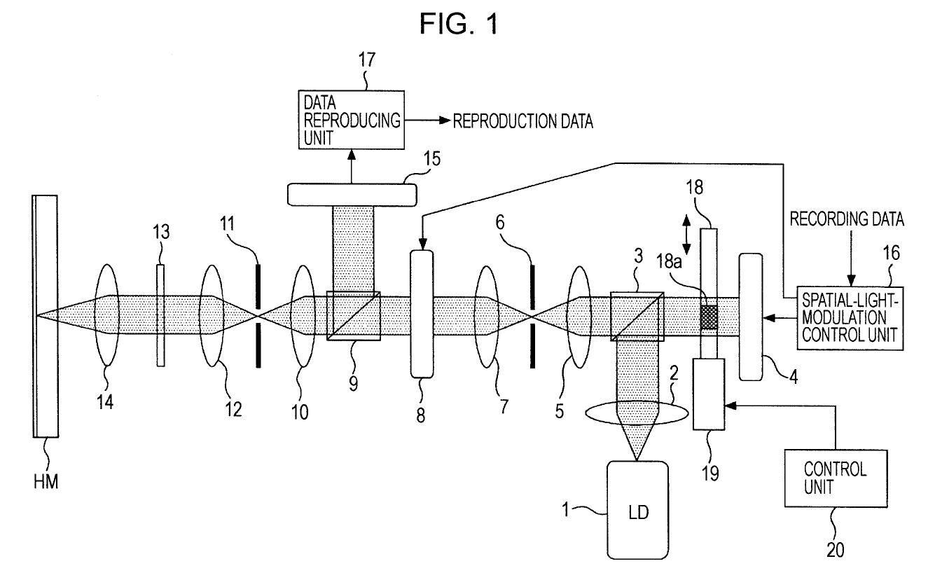

FIG. 1 is a block diagram illustrating the internal configuration of a recording/reproduction device according to a first embodiment. Each of embodiments to be described below is directed to a case where a reproduction device according to an embodiment of the present invention is configured to also serve as a recording/reproduction device having a recording function.

The recording/reproduction device according to the first embodiment shown in FIG. 1 is configured to perform hologram recording/reproduction based on a coaxial method. A coaxial method involves performing data recording by disposing signal light and reference light coaxially with each other and emitting these two kinds of light to a hologram recording medium set at a predetermined position so as to form a hologram thereon, and performing data reproduction by emitting reference light to a hologram recording medium to reproduce data recorded in the form of a hologram.

When recording, the recording/reproduction device according to the first embodiment performs phase modulation recording to improve the recording density. For reproduction, the recording/reproduction device according to the first embodiment performs reproduction based on a coherent addition method to achieve linear reading.

The recording/reproduction device according to the first embodiment is configured to be used with a reflective hologram recording medium having a reflective film as a hologram recording medium HM.

In FIG. 1, a laser diode (LD) 1 is provided as a light source for obtaining a laser beam for recording/reproduction. Specifically, the laser diode 1 is equipped with, for example, an external resonator and the wavelength of the laser beam is, for example, about 410 nm.

Light emitted from the laser diode 1 is guided to a polarization beam splitter 3 via a collimator lens 2.

The polarization beam splitter 3 is configured to transmit x-polarized light and reflect y-polarized light (of which the polarization direction is orthogonal to that of x-polarized light). Thus, of the laser beam (linearly-polarized beam) emitted from the laser diode 1 and entering the polarization beam splitter 3, the x-polarized light passes through the polarization beam splitter 3 whereas the y-polarized light is reflected by the polarization beam splitter 3.

The light reflected by the polarization beam splitter 3 (i.e., the y-polarized light) travels through a partial light-attenuating element 18, to be described later, so as to enter a polarization-direction controller 4.

The partial light-attenuating element 18 will be described later, and for the sake of convenience, the device will be described here as being in a state where such a partial light-attenuating element 18 is not inserted.

The polarization-direction controller 4 is equipped with a reflective liquid crystal element made of ferroelectric liquid crystal and is configured to control the polarization direction of incident light with respect to each pixel.

In accordance with a driving signal from a spatial-light-modulation control unit 16, the polarization-direction controller 4 performs spatial light modulation by changing the polarization direction of incident light for each pixel by 90° or without changing the polarization direction of incident light. Specifically, the polarization-direction controller 4 is configured to control the polarization direction with respect to each pixel in accordance with the driving signal such that, for a pixel corresponding to an ON driving signal, the angular change in the polarization direction is 90°, whereas for a pixel corresponding to an OFF driving signal, the angular change in the polarization direction is 0°.

As shown in the drawing, the output light from the polarization-direction controller 4 (i.e., the light reflected by the polarization-direction controller 4) re-enters the polarization beam splitter 3.

The recording/reproduction device shown in FIG. 1 is configured to perform spatial light intensity modulation (also referred to as “light intensity modulation” or simply as “intensity modulation”) with respect to individual pixels by utilizing the polarization-direction control performed by the polarization-direction controller 4 with respect to each pixel and the selectable transmitting/reflecting properties of the polarization beam splitter 3 depending on the polarization direction of incident light.

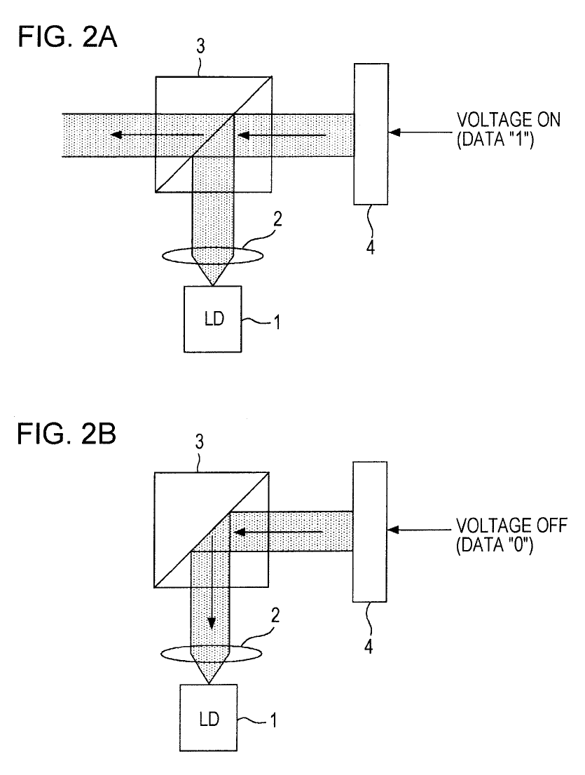

FIGS. 2A and 2B illustrate how an intensity modulation operation is performed by the combination of the polarization-direction controller 4 and the polarization beam splitter 3. Specifically, FIG. 2A schematically illustrates how a beam of light corresponding to an ON pixel travels, whereas FIG. 2B illustrates how a beam of light corresponding to an OFF pixel travels.

As mentioned above, since the polarization beam splitter 3 is configured to transmit x-polarized light and reflect y-polarized light, the y-polarized light is made to enter the polarization-direction controller 4.

In view of this, the pixel light whose polarization direction is changed by 90° by the polarization-direction controller 4 (i.e., the pixel light corresponding to an ON driving signal) enters the polarization beam splitter 3 as x-polarized light. Thus, referring to FIG. 2A, light corresponding to an ON pixel in the polarization-direction controller 4 is transmitted through the polarization beam splitter 3 and is guided towards the hologram recording medium HM.

On the other hand, the pixel light corresponding to an OFF driving signal and whose polarization direction is unchanged enters the polarization beam splitter 3 as y-polarized light. Specifically, referring to FIG. 2B, light corresponding to an OFF pixel in the polarization-direction controller 4 is reflected by the polarization beam splitter 3 and is not guided towards the hologram recording medium HM.

Consequently, the polarization-direction controller 4 that performs polarization-direction control with respect to each pixel and the polarization beam splitter 3 together constitute an intensity modulation unit that performs light intensity modulation with respect to each pixel.

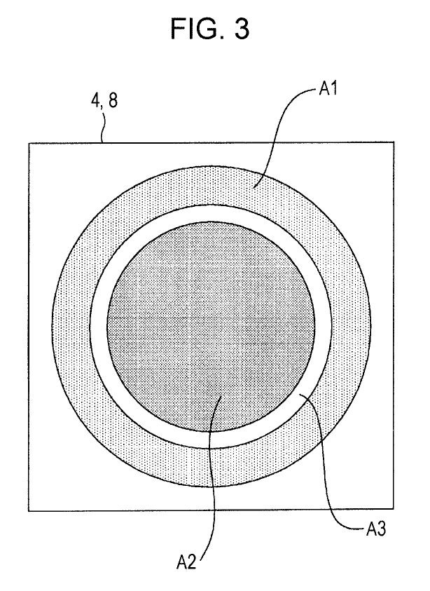

In the first embodiment, a coaxial method is employed as a hologram recording/reproduction method. When a coaxial method is employed, areas as shown in FIG. 3 are set in the polarization-direction controller 4 in order to dispose the signal light and the reference light coaxially with each other.

As shown in FIG. 3, the polarization-direction controller 4 has a signal-light area A2 covering a predetermined range with a substantially circular shape and including the center of the polarization-direction controller 4 (i.e., the center of the light axis). Moreover, a substantially ring-shaped reference-light area A1 surrounds the signal-light area A2 with a gap area A3 interposed therebetween.

With the signal-light area A2 and the reference-light area A1, the signal light and the reference light can be emitted such that they are coaxial with each other.

The gap area A3 is provided for preventing the reference light generated in the reference-light area A1 from leaking into the signal-light area A2 to act as noise on the signal light.

Referring back to FIG. 1, the spatial-light-modulation control unit 16 controls the driving of the polarization-direction controller 4 and the driving of a phase modulator 8 to be described later so as to generate, during recording, signal light and reference light that are given, for example, a binary random phase pattern (in which the number of phase “0” and the number of phase “π” are substantially equal) for phase modulation recording or to generate, during reproduction, coherent light and reference light having the same intensity and the same phase pattern as those for recording.

The operation of the spatial-light-modulation control unit 16 will be described in detail below.

Light traveling via the polarization-direction controller 4 and then passing through the polarization beam splitter 3 is guided to a relay lens system including a relay lens 5, an aperture 6, and a relay lens 7 arranged in that order, as shown in FIG. 1. As shown in the drawing, the relay lens 5 focuses the laser beam transmitted through the polarization beam splitter 3 onto a predetermined focal position, and the laser beam, which is diffused after being focused, is collimated by the relay lens 7. The aperture 6 is provided at the focal position (i.e., a Fourier plane: frequency plane) of the relay lens 5 and is configured to only transmit light within a predetermined range centered on the light axis but to block the remaining light. The aperture 6 limits the size of a hologram page to be recorded on the hologram recording medium HM, thereby improving the recording density (i.e., the data recording density) of the hologram.

The laser beam traveling through the relay lens system is guided to the phase modulator 8. The phase modulator 8 is configured to perform spatial light phase modulation (also simply referred to as phase modulation) on the incident light with respect to each pixel and has a reference-light area A1, a signal-light area A2, and a gap area A3 similar to those of the polarization-direction controller 4.

In order to match the phase modulator 8 in terms of pixels with the polarization-direction controller 4 (that is, to match the pixels of the polarization-direction controller 4 and the pixels of the phase modulator 8 so they respectively have a one-to-one relationship), the phase modulator 8 is adjusted such that the installation position thereof is aligned with a position corresponding to a real image plane of the polarization-direction controller 4 formed by the relay lens system and that a position on a plane parallel to the incident face thereof allows light beams traveling through the reference-light area A1, the signal-light area A2, and the gap area A3 of the polarization-direction controller 4 to respectively enter the reference-light area A1, the signal-light area A2, and the gap area A3 of the phase modulator 8.

In the first embodiment, the phase modulator 8 is defined by a transmissive liquid crystal panel in which phase modulation can be variably performed with respect to the individual pixels.

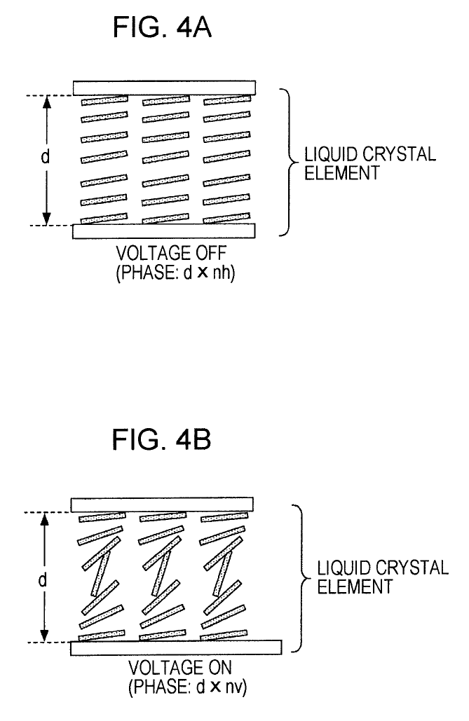

Such a liquid crystal panel that can variably perform phase modulation with respect to the individual pixels can be obtained by forming an internal liquid crystal element on the basis of the concept shown in FIGS. 4A and 4B.

FIG. 4A illustrates the condition of the liquid crystal element within the liquid crystal panel when a driving voltage is not applied to the light crystal element (that is, when the driving voltage is OFF). FIG. 4B illustrates the condition of the liquid crystal element when a driving voltage of a predetermined level is applied to the light crystal element (that is, when the driving voltage is ON).

When the driving voltage is OFF as in FIG. 4A, the liquid crystal molecules are oriented in the horizontal direction, whereas when the driving voltage is ON as in FIG. 4B, the liquid crystal molecules are oriented in the vertical direction.

In this case, with regard to a refractive index n of the liquid crystal element, if the refractive index during the horizontally oriented state corresponding to the OFF driving voltage is denoted by nh and the refractive index during the vertically orientated state corresponding to the ON driving voltage at a predetermined level is denoted by nv, an amount of change in phase given during the OFF driving voltage state is (d×nm) and an amount of change in phase given during the ON driving voltage state is (d×nv), d being the thickness of the liquid crystal element. Accordingly, a phase difference Δnd that can be given according to the ON/OFF state of the driving voltage is expressed as follows:

Δnd=d×nh−d×nv

This relational expression shows that the thickness d of the liquid crystal element may be adjusted in order to give a desired phase difference for each pixel.

The phase modulator 8 according to the first embodiment is set such that, for example, the phase difference Δnd is made equal to π by adjusting the thickness d of the liquid crystal element. In other words, by switching between the driving voltages ON and OFF for each pixel, light phase modulation based on the two values “0” and “π” can be implemented.

With the capability to perform the modulation of the phases “0” and “π” on the basis of the ON driving voltage at the predetermined level and the OFF driving voltage, the phase can be varied stepwise between “0” and “π” by controlling the driving voltage level in a stepwise manner up to the predetermined level. For example, by setting the driving voltage level to half the predetermined level, modulation by phase “π/2” is also possible.

For confirmation, such a phase modulator 8 is used in a state where the direction of a reference optical axis thereof is aligned with the polarization direction of incident light (in this case, the x-direction).

Referring back to FIG. 1, light passing through the phase modulator 8 is guided to a polarization beam splitter 9. The polarization beam splitter 9 is also configured to transmit x-polarized light and reflect y-polarized light. Therefore, a laser beam guided via the phase modulator 8 is transmitted through the polarization beam splitter 9.

The laser beam transmitted through the polarization beam splitter 9 is guided to a relay lens system including a relay lens 10, an aperture 11, and a relay lens 12 arranged in that order. This relay lens system has the same effect as that of the above-described relay lens system including the relay lens 5, the aperture 6, and the relay lens 7.

The laser beam traveling through the relay lens system including the relay lens 10, the aperture 11, and the relay lens 12 subsequently passes through a quarter-wave plate 13 and is then emitted by an objective lens 14 towards the recording face of the hologram recording medium HM so as to be focused thereon.

Although the following will also be described later, the intensity modulation unit constituted by the combination of the polarization-direction controller 4 and the polarization beam splitter 3 and the phase modulator 8 perform spatial light modulation during recording so as to generate signal light and reference light. Therefore, when recording, the signal light and the reference light are emitted towards the hologram recording medium HM along the light path described above, whereby an interference pattern (diffraction grating: hologram) of the signal light and the reference light is formed on the hologram recording medium HM. In other words, data is consequently recorded.

On the other hand, when performing reproduction, the intensity modulation unit constituted by the combination of the polarization-direction controller 4 and the polarization beam splitter 3 and the phase modulator 8 perform spatial light modulation so as to generate reference light and coherent light. The reference light is emitted towards the hologram recording medium HM along the above-described light path, whereby diffracted light according to a hologram formed on the hologram recording medium HM is obtained as reproduction light (i.e., a reproduction image). This reproduction light is returned towards the recording/reproduction device as reflected light from the hologram recording medium HM.

The coherent light is reflected by the hologram recording medium HM so as to be returned towards the recording/reproduction device.

The reproduction light and the coherent light obtained as reflected light from the hologram recording medium HM in this manner travel through the objective lens 14 and are subsequently guided to the polarization beam splitter 9 via the quarter-wave plate 13, the relay lens 12, the aperture 11, and the relay lens 10.

The reproduction light enters the polarization beam splitter 9 as y-polarized light due to the effect of the quarter-wave plate 13. Therefore, the reproduction light is reflected by the polarization beam splitter 9 and is guided towards an image sensor 15. The coherent light is also reflected by the polarization beam splitter 9 and is guided towards the image sensor 15.

The image sensor 15 includes an image pickup element, such as a charge-coupled-device (CCD) sensor or a complementary metal oxide semiconductor (CMOS) sensor. The image sensor 15 optically receives the reproduction light (reproduction image) and the coherent light guided in the above-described manner from the hologram recording medium HM and converts them into an electric signal. Consequently, during reproduction, an optically received signal (i.e., an image signal) that expresses a light intensity detection result indicating the reproduction image (i.e., a recorded image) and the component of coherent light added thereto is obtained.

The image signal (reproduction image+coherent light) obtained by the image sensor 15 is supplied to a data reproducing unit 17.

The data reproducing unit 17 performs predetermined reproduction-signal processing and decoding on the image signal so as to reproduce the recorded data. The internal configuration and the operation of the data reproducing unit 17 will be described later.

Phase Modulation Recording

The recording/reproduction device shown in FIG. 1 is provided with the aperture 6 (and the aperture 11) so that high recording density is achieved in accordance with reduction in the area occupied by a hologram page on a medium.

For confirmation, a hologram page is equivalent to an interference pattern formed by single emission of signal light and reference light. In other words, a hologram page can be defined as a minimum unit of data that can be recorded on the hologram recording medium HM.

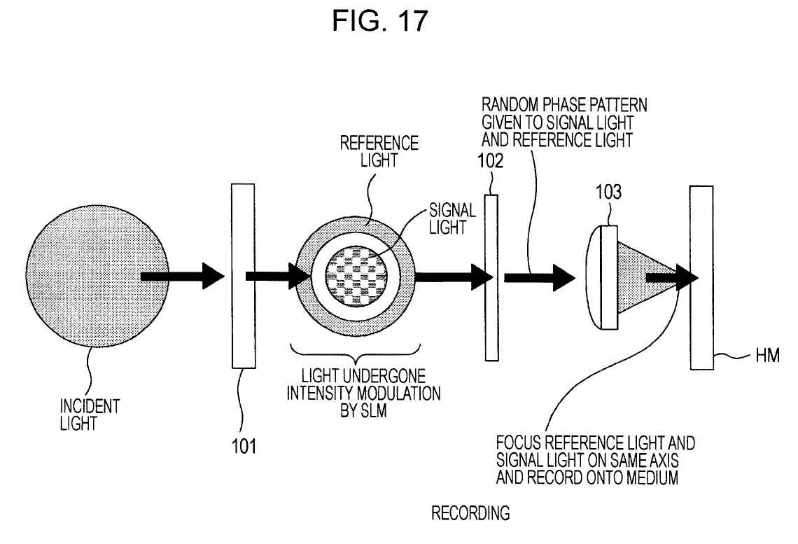

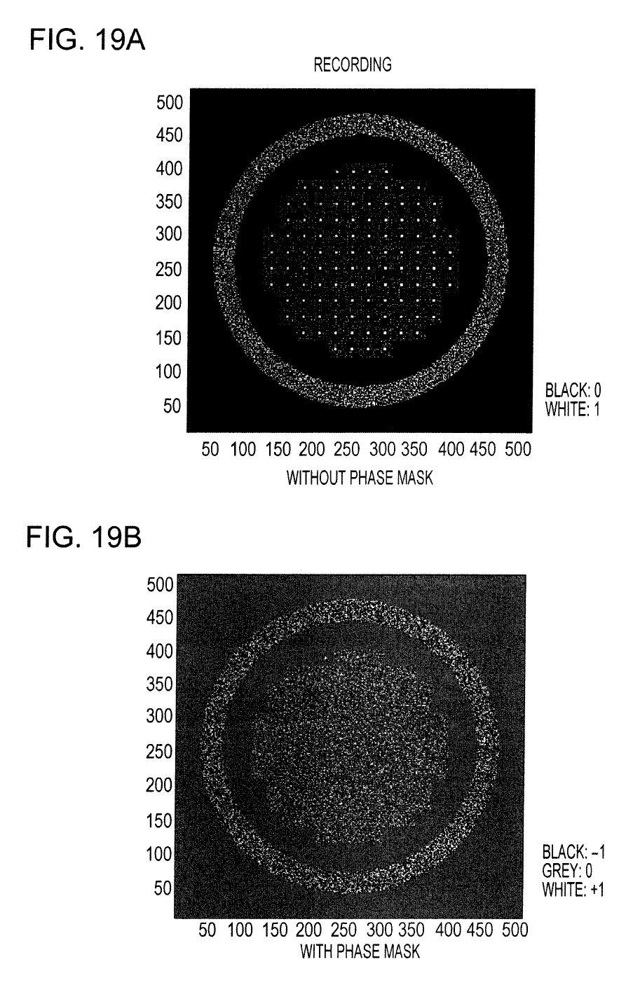

In the recording/reproduction device according to the first embodiment, in addition to the achievement of high recording density due to the reduced occupied area of a hologram page by such apertures, the recording density is also improved by minimizing a DC component, which is achieved by performing recording by emitting signal light and reference light that are given “0” and “π” phase modulation (e.g., a binary random phase pattern), as described previously with reference to FIG. 17 and FIGS. 19A and 19B. In other words, the recording density is improved by phase modulation recording.

In FIG. 1, such phase modulation recording is performed by allowing the spatial-light-modulation control unit 16 to control the driving of the polarization-direction controller 4 and the phase modulator 8.

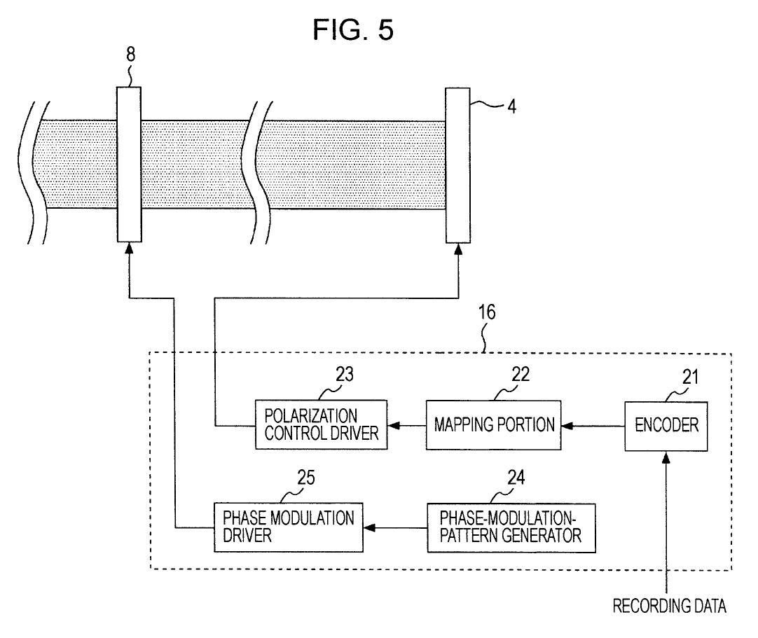

FIG. 5 is an extracted view of the polarization-direction controller 4, the phase modulator 8, and the spatial-light-modulation control unit 16 shown in FIG. 1 as well as the internal configuration of the spatial-light-modulation control unit 16. In FIG. 5, the light entering and exiting the polarization-direction controller 4 and the light entering and exiting the phase modulator 8 are also shown.

Referring to FIG. 5, the spatial-light-modulation control unit 16 contains an encoder 21, a mapping portion 22, a polarization control driver 23, a phase-modulation-pattern generator 24, and a phase modulation driver 25.

First, when recording, the encoder 21 receives recording data, as shown in FIG. 1. With respect to the input recording data, the encoder 21 performs predetermined recording-modulation encoding according to the recording format.

The mapping portion 22, when recording, maps the data encoded by the encoder 21 within the signal-light area A2 in accordance with the recording format. Specifically, with such mapping of the data in the signal-light area A2, a data pattern equivalent to one hologram page is generated.

In addition to performing such data mapping in the signal-light area A2, the mapping portion 22 generates a data pattern in which predetermined pixels in the reference-light area A1 are set as “1”, the remaining pixels therein are set as “0”, and the pixels in the gap area A3 and outside the reference-light area A1 are all set as “0”. Moreover, by adding this data pattern and the data pattern within the signal-light area A2 together, the mapping portion 22 generates a data pattern corresponding to the overall effective pixels of the polarization-direction controller 4.

The data pattern corresponding to the overall effective pixels of the polarization-direction controller 4 generated in this manner is supplied to the polarization control driver 23. The polarization control driver 23 controls the driving of the individual pixels of the polarization-direction controller 4 on the basis of this data pattern.

In consequence, the output light from the polarization beam splitter 3 towards the objective lens 14 shown in FIG. 1 during recording includes light that is to become signal light intensity-modulated based on a pattern according to the recording data and light that is to become reference light intensity-modulated based on a predetermined pattern.

In addition to controlling the driving of the polarization-direction controller 4 as mentioned above (i.e., performing the operation for intensity modulation), the spatial-light-modulation control unit 16 also controls the driving of the phase modulator 8 during recording.

First, the phase-modulation-pattern generator 24 generates a phase modulation pattern to be set within the signal-light area A2 of the phase modulator 8 on the basis of a predetermined data pattern. In this embodiment, a binary random phase pattern is set as a phase modulation pattern to be given during phase modulation recording.

Moreover, the phase-modulation-pattern generator 24 additionally generates a predetermined phase modulation pattern to be set in the reference-light area A1 of the phase modulator 8. A binary random phase pattern is also set as a phase modulation pattern to be set in the signal-light area A2.

The phase-modulation-pattern generator 24 then adds the phase modulation patterns (i.e., control patterns for corresponding pixels) respectively generated for the signal-light area A2 and the reference-light area A1 in this manner so as to generate a phase modulation pattern corresponding to the overall effective pixels of the phase modulator 8. In this case, a value corresponding to phase “0”, for example, is set for pixels outside the signal-light area A2 and the reference-light area A1.

The phase modulation pattern generated in this manner is then supplied to the phase modulation driver 25.

Based on the phase modulation pattern supplied from the phase-modulation-pattern generator 24, the phase modulation driver 25 controls the driving of the individual pixels of the phase modulator 8. Accordingly, signal light and reference light that are each phase-modulated based on a binary random phase pattern can be obtained as signal light output from the phase modulator 8.

Coherent Addition

As mentioned previously, in a hologram recording/reproduction system that only emits reference light during reproduction, the image sensor that detects an image signal about an image to be reproduced has nonlinear properties in terms of not having the capability to detect phase information.

In a system that only emits reference light during reproduction due to such nonlinear properties, it is extremely difficult to reproduce data properly.

In light of this, the recording/reproduction device according to this embodiment is configured to perform reproduction based on a coherent addition method in which the device emits coherent light in addition to reference light during reproduction to allow for linear reading.

In this case, the term “coherent light” refers to light in which its amplitude and phase are uniform. In detail, the phase is set equal to a reference phase within a reproduction image obtained from the hologram recording medium HM in accordance with the emission of the reference light, and the intensity is adjusted such that the intensity of the light when added to the reproduction image is greater than an absolute value of the minimum amplitude value of the reproduction image.

The term “reference phase within a reproduction image” refers to a phase of a pixel recorded while being modulated by phase “0” during recording.

In order to perform reading by emitting coherent light and reference light in this manner, the spatial-light-modulation control unit 16 shown in FIG. 5 performs the following operation for reproduction.

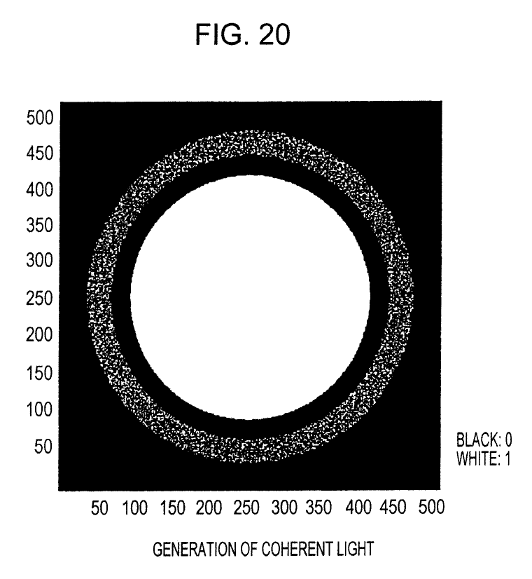

First, the coherent light to be emitted together with the reference light is generated in an area (i.e., a beam area of signal light) where signal light is generated when recording (see FIG. 20).

When performing reproduction, the mapping portion 22 in the spatial-light-modulation control unit 16 generates a data pattern in which the reference-light area A1 is given “0” and “1” patterns, as in recording, the signal-light area A2 is entirely given “1”, and the remaining regions are entirely given “0”. This data pattern is subsequently supplied to the polarization control driver 23.

The polarization control driver 23 controls the driving of the individual pixels of the polarization-direction controller 4 in accordance with the data patterns for all of the pixels of the polarization-direction controller 4 supplied from the mapping portion 22. In consequence, the output light from the polarization beam splitter 3 towards the objective lens 14 shown in FIG. 1 includes light that is to become reference light given the same intensity pattern as that during recording and light that is to become coherent light with a uniform light intensity of “1” within the entire beam area of signal light.

Furthermore, the phase-modulation-pattern generator 24 and the phase modulation driver 25 in FIG. 5 perform the following operations during reproduction.

Specifically, the phase-modulation-pattern generator 24 generates a data pattern as a phase modulation pattern similar to that during recording for the reference-light area A1 of the phase modulator 8 and also generates a data pattern that fills the entire signal-light area A2 with predetermined values. By adding these data patterns together, data corresponding to the overall effective pixels of the phase modulator 8 is generated, and is then supplied to the phase modulation driver 25.

As described above with reference to FIGS. 4A and 4B, the phase modulator 8 is configured to variably modulate the phase of the individual pixels in accordance with the driving voltage level. In detail, the phase of each pixel can be variably modulated within a range of “0” and “π” in accordance with the driving voltage level.

The phase modulation driver 25 is thus configured to drive each pixel of the phase modulator 8 on the basis of the driving voltage level according to values “0” to “1” (e.g., 0 to 255 in 256 gradation) from the phase-modulation-pattern generator 24.

When the signal-light area A2 is filled with predetermined values by the data pattern generated by the phase-modulation-pattern generator 24 in this manner, the phase modulation driver 25 drives the individual pixels in the signal-light area A2 of the phase modulator 8 in accordance with the corresponding values. In consequence, the phase of coherent light obtained as a result of being transmitted through the signal-light area A2 can be variably set in accordance with the predetermined values.

The phase of coherent light is conditionally set equal to the reference phase within the reproduction image, as mentioned above. In order to set the phase equal to the reference phase within the reproduction image, the phase modulation amount to be given to the coherent light (within the signal-light area A2) by the phase modulator 8 is an amount that allows for a phase difference of π/2 with respect to the reference phase when the phase of pixels given phase “0” modulation by the same phase modulator 8 during recording is set as a reference phase of “0”. In other words, the phase modulator 8 may perform phase modulation by a phase modulation amount of π/2 within the signal-light area A2.

The reason that phase modulation by π/2 is given to the coherent light is as follows.

Specifically, in a hologram recording/reproduction method, when a reproduction image is obtained by emitting reference light to the hologram recording medium HM, the phase of the reproduction image deviates by π/2 with respect to the phase of the recording signal (see H. Kogelnik, “Coupled Wave Theory for Thick Hologram Grating”, Bell System Technical Journal, 48, 2909-2947 regarding this phenomenon). In view of this point, the reference phase within the reproduction image may not remain to be “0” and may deviate by π/2. Therefore, the phase to be given to the coherent light may be set to π/2.

In this manner, when generating coherent light, the phase modulator 8 performs modulation by phase “π/2” for the individual pixels within the signal-light area A2.

In order to perform such modulation by phase “π/2”, the phase-modulation-pattern generator 24 allocates a value “0.5” (i.e., a value corresponding to “127” in 256 gradation) to the signal-light area A2.

With the operation of the spatial-light-modulation control unit 16 described above, the hologram recording medium HM, during reproduction, is irradiated with reference light in addition to coherent light whose phase is equal to the reference phase within a reproduction image and whose intensity is greater than an absolute value of the minimum amplitude value of the reproduction image. In other words, in this embodiment, the reference light is emitted to obtain a reproduction image of data recorded on the hologram recording medium HM, and the coherent light, after being emitted to the hologram recording medium HM, is guided as reflected light to the image sensor 15 together with the reproduction image.

In this case, since the phase of the coherent light is modulated so that it is equal to that of the reproduction image, the coherent light is added as a component with the same phase as that of the reproduction image when the coherent light forms an image on the image sensor 15. Consequently, the image sensor 15 obtains a readout signal about the reproduction image having the coherent light added thereto as an added component.

In this embodiment, the data reproducing unit 17 shown in FIG. 1 reproduces recorded data on the basis of the readout signal (image signal), obtained by the image sensor 15, about the reproduction image with the coherent light added thereto.

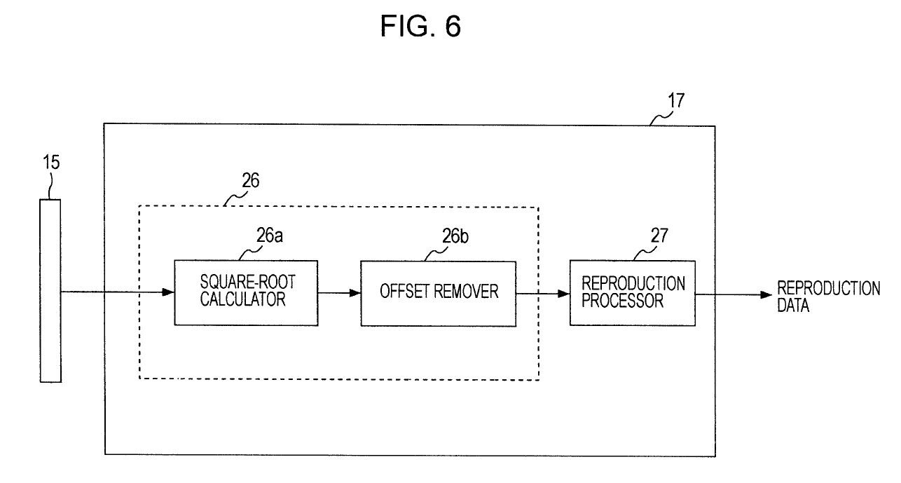

FIG. 6 illustrates the internal configuration of the data reproducing unit 17. In FIG. 6, the image sensor 15 is also shown.

As shown in FIG. 6, the data reproducing unit 17 is provided with a linearization processor 26 and a reproduction processor 27.

The linearization processor 26 receives the image signal as a detection result about the coherent light and the reproduction light obtained by the image sensor 15 so as to perform processing for linear reading.

The linearization processor 26 in this case is equipped with a square-root calculator 26a and an offset remover 26b, as shown in FIG. 6.

The square-root calculator 26a calculates the square root of each value included in the image signal obtained by the image sensor 15 and supplies the calculated result to the offset remover 26b.

For confirmation, depending on the image sensor 15, the intensity of detected light is expressed with, for example, an amplitude value based on predetermined gradation, such as 256 gradation. The square-root calculator 26a is configured to calculate the square root with respect to an amplitude value of each pixel of the image sensor 15.

The offset remover 26b performs processing for removing the component of coherent light (i.e., an offset component with respect to the reproduction image which is a detection object) from the square-root value obtained by the square-root calculator 26a. Specifically, the offset remover 26b in this case performs processing for subtracting a value corresponding to the added amount of coherent light from the square-root value of the amplitude value of each pixel obtained by the square-root calculator 26a.

In the case of this embodiment, the added amount of coherent light (i.e., the intensity of coherent light added to the reproduction image) is also adjusted by a light-attenuating unit according to an embodiment to be described later. The value to be subtracted from the calculated square-root value in the offset remover 26b undergoes an adjustment by such a light-attenuating unit so as to ultimately set the value of the intensity of coherent light when it is to be added to the reproduction image (i.e., when the coherent light forms an image at the image sensor 15).

Although a technique of subtracting the value of added amount of coherent light from the calculated square-root value is described here as an example of removing the added component of coherent light, the added component of coherent light may be removed by other alternative methods, such as filtering in which a DC component is removed from the image signal serving as the calculated square-root value obtained by the square-root calculator 26a.

By performing linearization processing as described above with respect to the detection result of the coherent light and the reproduction image, a linear readout signal that properly expresses phase information recorded on the hologram recording medium HM by phase modulation recording can be obtained. In detail, a signal that properly expresses a difference in amplitudes of “+1” and “−1” recorded by phase modulation recording can be obtained. As described previously, supposing that a maximum value corresponding to an amplitude of “+1” of a reproduction image is “0.078” and a minimum value corresponding to an amplitude of “−1” is “−0.078”, and that the added amount of coherent light is set to “0.1” which is greater than the absolute value “0.078” of the minimum value of the reproduction image, the image sensor 15 detects an intensity of 0.178²=0.032 for the maximum value 0.078 and an intensity of 0.022²=4.8E-4 for the minimum value −0.078. By performing the linearization processing with respect to these detection results 0.032 and 4.8E-4, the original value can be restored for the maximum value 0.078 of the amplitude of the reproduction image on the basis of (0.178−0.1=0.078), and the original value can be restored for the minimum value −0.078 on the basis of (0.022−0.1=−0.078).

By employing the reproduction technique based on the coherent addition method in which linearization processing is implemented by performing square-root calculation and removing the added amount of coherent light from the detection result of the coherent light and the reproduction image, a linear readout signal can be obtained in which phase information recorded by phase modulation recording is not lost.

The linear readout signal obtained as the result of the linearization processing performed by the linearization processor 26 is supplied to the reproduction processor 27.

The reproduction processor 27 reproduces recorded data on the basis of an image signal defined by the linear readout signal, thereby obtaining reproduction data.

In detail, the reproduction processor 27 performs equalizing on the image signal defined by the linear readout signal so as to reduce intersymbol interference (i.e., interference between pixels). Moreover, the reproduction processor 27 performs re-sampling on the equalized image signal so as to obtain values (data-pixel values), included in the image signal, for the individual pixels of the polarization-direction controller 4. Furthermore, the reproduction processor 27 performs, for example, data identification processing between “0” and “1” based on each data-pixel value obtained by re-sampling and also performs decoding with respect to the recording-modulation encoding performed by the encoder 21 described above, so as to reproduce the recorded data.

In this embodiment, although the amplitude information to be recorded on the hologram recording medium HM by phase modulation recording includes three values “+1” “0”, and “−1”, the values “+1” and “−1” are both recorded as data “1”. Therefore, the amplitude information about these values “+1” and “−1” are both identified as data “1” during reproduction. In other words, when performing data identification processing, the reproduction processor 27 identifies a value corresponding to an amplitude “0” as data “0” and values corresponding to amplitudes “+1” and “−1” as data “1”.

Partial Light-Attenuating Technique According to First Embodiment

As described previously, a hologram recording/reproduction system emits reference light to a hologram recorded on a hologram recording medium HM during reproduction and obtains a reproduction image by utilizing a diffraction phenomenon that occurs accordingly. In view of this point, it is apparent that the light amount (light intensity) of a reproduction image in a hologram recording/reproduction system is dependent on the diffraction efficiency of the hologram recorded on the hologram recording medium HM.

Generally, a diffraction efficiency η in a hologram recording/reproduction system is about 10⁻³ to 10⁻⁴.

On the other hand, the intensity of coherent light to be added to a reproduction image is determined only on the basis of the amount of loss of light that occurs while the light output from the intensity modulation unit (i.e., the polarization-direction controller 4 and the polarization beam splitter 3) is guided to the image sensor 15 via the hologram recording medium HM. In other words, since the coherent light simply does not experience such loss in the amount of light by the aforementioned diffraction efficiency, the coherent light apparently has an extremely high intensity as compared with the intensity of the reproduction image.

In this embodiment, the intensity modulation unit constituted by the combination of the polarization-direction controller 4 and the polarization beam splitter 3 generates light that is to become coherent light by causing the light to be transmitted through the beam area of signal light.

The polarization-direction controller (FLC) 4 is configured to change the polarization direction of incident light by 90° or 0° depending on whether the driving voltage is ON or OFF. Accordingly, the coherent light is adjusted to an intensity of “1” by the intensity modulation unit including such a polarization-direction controller 4.

When the intensity of the coherent light is adjusted to “1” as in this manner, an amplitude I detected by the image sensor 15 (both an amplitude of a pixel with a recorded amplitude of “1” and an amplitude of a pixel with a recorded amplitude of “−1”) is expressed as follows, as described previously:

I=(1±\sqrt{η})² (3)

In this case, if the diffraction efficiency η is equal to 10⁻⁴,

I−(1±\sqrt{10⁻⁴})²=(1±10⁻²)²=1.02, 0.98 (4)

This indicates that the contrast of the reproduction image (amplitude “+1” to amplitude “−1”) with respect to the intensity of the coherent light, which is to serve as background light, is extremely low. In this case, it may be necessary to detect a slight intensity difference of 2%.

It is extremely difficult to detect such a reproduction image having low contrast with high accuracy, making deterioration in reproduction characteristics unavoidable in the related art.

In light of this, a light-attenuating unit for attenuating the intensity of coherent light is provided in this embodiment. With the light-attenuating unit, the contrast of the reproduction image is relatively enhanced, thereby improving the reproduction characteristics.

As shown in FIG. 1, the recording/reproduction device according to the first embodiment is provided with a partial light-attenuating element 18, a slide driver 19, and a control unit 20.

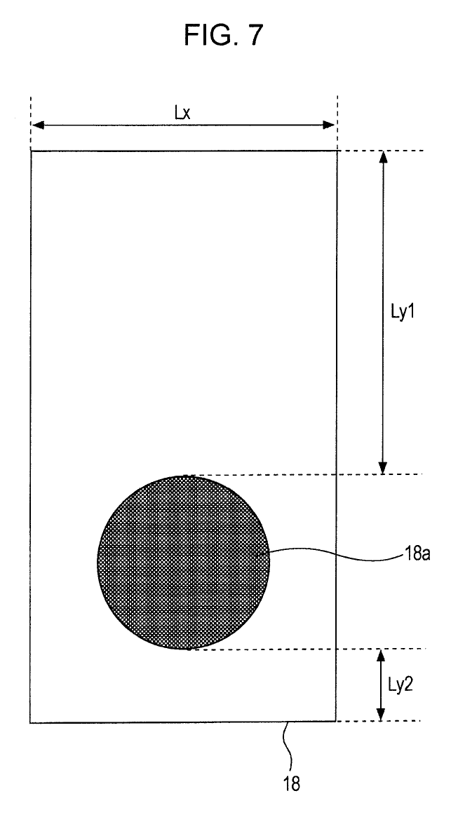

Specifically, the partial light-attenuating element 18 has the structure shown in FIG. 7.

As shown in FIG. 7, the partial light-attenuating element 18 is partially provided with a light-attenuating portion 18a composed of a light-attenuating material. For example, the light-attenuating portion 18a is composed of a metal film, such as a chromium film.

The area excluding the light-attenuating portion 18a in the partial light-attenuating element 18 is composed of a material having satisfactory optical transparency, such as transparent glass or transparent resin.

The light-attenuating material used for forming the light-attenuating portion 18a is not particularly limited so long as it can attenuate incident light by transmitting a portion of the incident light and absorbing (and/or reflecting) another portion thereof.

As described previously, it may be necessary to set the intensity of coherent light to be added to a reproduction image such that the intensity is at least greater than an absolute value of the minimum value of the reproduction image. With respect to the light-attenuating portion 18a, the factors that determine the light-attenuating rate (i.e., the transmittance) thereof, such as the constituent material and the film pressure thereof, may be set such that the factors at least satisfy this condition regarding the intensity of coherent light.

For example, in this embodiment, the transmittance by the light-attenuating portion 18a is set to about 1% to 0.1%.

The light-attenuating portion 18a is given an area size that is greater than or equal to the size of the signal-light area A2 and does not to overlap the reference-light area A1.

The overall size of the partial light-attenuating element 18 is set such that a length Lx thereof in the x-direction within a plane parallel to the incident face thereof is at least greater than or equal to the diameter of the reference-light area A1. The diameter of the reference-light area A1 in this case is the diameter of an outer circle of the reference-light area A1.

The length of the partial light-attenuating element 18 in the y-direction orthogonal to the x-direction is set such that a length Ly1 from one end of the light-attenuating portion 18a to one end of the partial light-attenuating element 18 is at least greater than or equal to the diameter of the reference-light area A1. A length Ly2 from the other end of the light-attenuating portion 18a to the other end of the partial light-attenuating element 18 is set greater than or equal to the distance from an edge of the signal-light area A2 to the outer circle of the reference-light area A1.

In the first embodiment, the light-attenuating portion 18a in the partial light-attenuating element 18 having the structure shown in FIG. 7 is moved into and away from the light path between the recording mode and the reproduction mode so that light (i.e., coherent light) generated within the beam area of the signal light is attenuated only during reproduction.

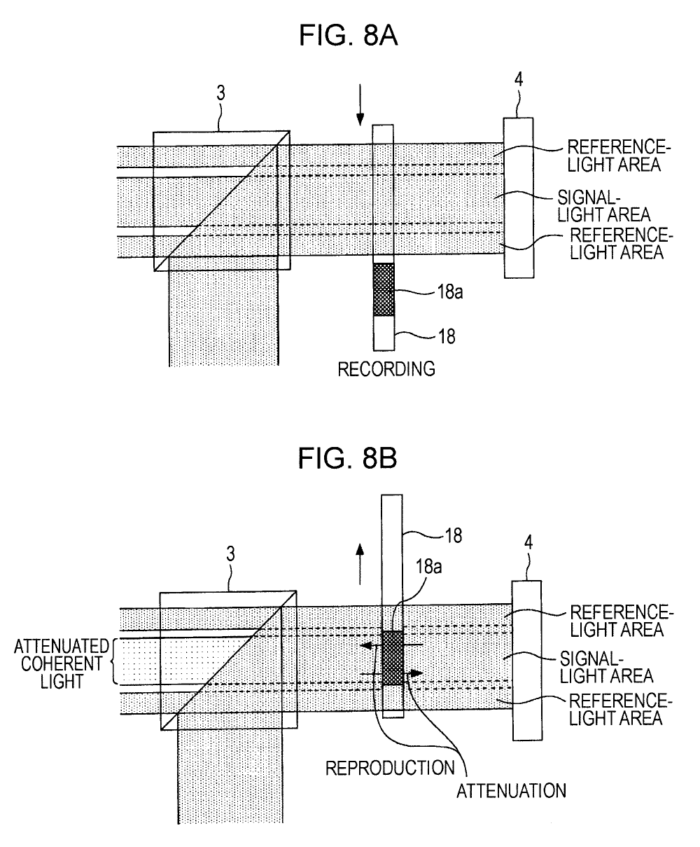

FIGS. 8A and 8B schematically illustrate a light-attenuating technique according to the first embodiment. Specifically, FIGS. 8A and 8B show the driven states of the partial light-attenuating element 18 during the recording mode and the reproduction mode, respectively.

As shown in FIG. 8A, when recording, the partial light-attenuating element 18 is driven such that the light-attenuating portion 18a in the partial light-attenuating element 18 is removed from the light path. In detail, the partial light-attenuating element 18 is slidably driven such that the area excluding the light-attenuating portion 18a in the partial light-attenuating element 18 (i.e., an area indicated by Ly1 in FIG. 7) covers a range of the reference light. Thus, the hologram recording medium HM can be irradiated with the signal light and the reference light during recording, as described above. In other words, normal data recording can be performed.

On the other hand, when performing reproduction, as shown in FIG. 8B, the partial light-attenuating element 18 is driven such that the light-attenuating portion 18a in the partial light-attenuating element 18 is inserted into the light path. Specifically, in this case, the partial light-attenuating element 18 is driven to an insertion position within the optical system such that the light that is to become incident on the signal-light area A2 of the polarization-direction controller 4 is entirely made to enter the light-attenuating portion 18a. In this embodiment, since the signal-light area A2 is disposed inside the reference-light area A1 and the center of the signal-light area A2 is aligned with the light axis of a laser beam, the partial light-attenuating element 18 may be driven such that the center of the light-attenuating portion 18a is aligned with the light axis.

By driving the partial light-attenuating element 18 in this manner, the intensity of coherent light obtained within the beam area of signal light can be attenuated to a predetermined intensity during reproduction. On the other hand, since the light-attenuating portion 18a is made so as not to overlap the beam area of reference light, the reference light can be emitted to the hologram recording medium HM as usual.

As is apparent from FIG. 8B, the insertion position of the partial light-attenuating element 18 in this case is between the polarization beam splitter 3 and the polarization-direction controller 4, and the light that is to become the coherent light travels back and forth through the light-attenuating portion 18a. In other words, the coherent light in this case has its intensity adjusted by undergoing attenuation twice in the light-attenuating portion 18a.

The transmittance of the light-attenuating portion 18a in this case is set such that a predetermined intensity is obtained with respect to an added amount of coherent light in view of the fact that the light that is to become the coherent light passes therethrough twice.

The driving of the partial light-attenuating element 18 between the recording and reproduction modes is performed by the slide driver 19 and the control unit 20 shown in FIG. 1.

In FIG. 1, the slide driver 19 slides the partial light-attenuating element 18 on the basis of a driving signal from the control unit 20. For example, the slide driver 19 in this case has a mechanism that converts a rotational driving force of a motor into a driving force in the sliding direction. The slide driver 19 is configured to slide the partial light-attenuating element 18 when the motor is driven in response to the driving signal from the control unit 20.

According to the description above, the partial light-attenuating element 18 is preferably driven such that the light-attenuating portion 18a is removed from the light path for the recording mode. On the other hand, for the reproduction mode, the partial light-attenuating element 18 is preferably driven to align the center of the light-attenuating portion 18a with the light axis so that the light that is to become incident on the signal-light area A2 of the polarization-direction controller 4 is entirely made to enter the light-attenuating portion 18a.

The control unit 20 sends a driving signal based on a preset polarity and pulse width (time) to the slide driver 19 so that a driven state of the partial light-attenuating element 18 corresponding to the recording mode or the reproduction mode can be obtained. Accordingly, the two driven states of the partial light-attenuating element 18 corresponding to the recording mode and the reproduction mode can be obtained.

In order to obtain the two driven states of the partial light-attenuating element 18 corresponding to the recording mode and the reproduction mode, a technique in which a stopper (positioning member) that limits the sliding distance of the partial light-attenuating element 18 for obtaining the recording-mode/reproduction-mode driven states may be employed. In that case, the control unit 20 may at least be configured to switch the polarity of the driving signal (i.e., switch the sliding direction) between the recording and reproduction modes.

With the recording/reproduction device according to the first embodiment, the intensity of coherent light generated on the basis of intensity modulation performed by the intensity modulation unit can be attenuated to a predetermined intensity by the partial light-attenuating element 18. With such attenuation of the coherent light, the contrast of a reproduction image to be detected by the image sensor 15 can be enhanced, thereby ultimately improving the reproduction characteristics.

### 2. SECOND EMBODIMENT (EXAMPLE THAT USES PARTIAL POLARIZATION-DIRECTION CONTROLLING ELEMENT)

### 2.1. First Example (Slidably-Driving Partial Polarization-Direction Controlling Element)

In a second embodiment, a light-attenuating unit including a combination of a partial polarization-direction controlling element, which partially changes the polarization direction of incident light, and a polarization beam splitter is used to attenuate the coherent light. Specifically, the partial polarization-direction controlling element controls the polarization direction so that the coherent light can be attenuated at the polarization beam splitter.

A first example and a second example will be described below as examples of techniques according to the second embodiment.

In the first example of the second embodiment, the partial polarization-direction controlling element is slidably driven in a similar manner to the first embodiment so as to attenuate the coherent light.

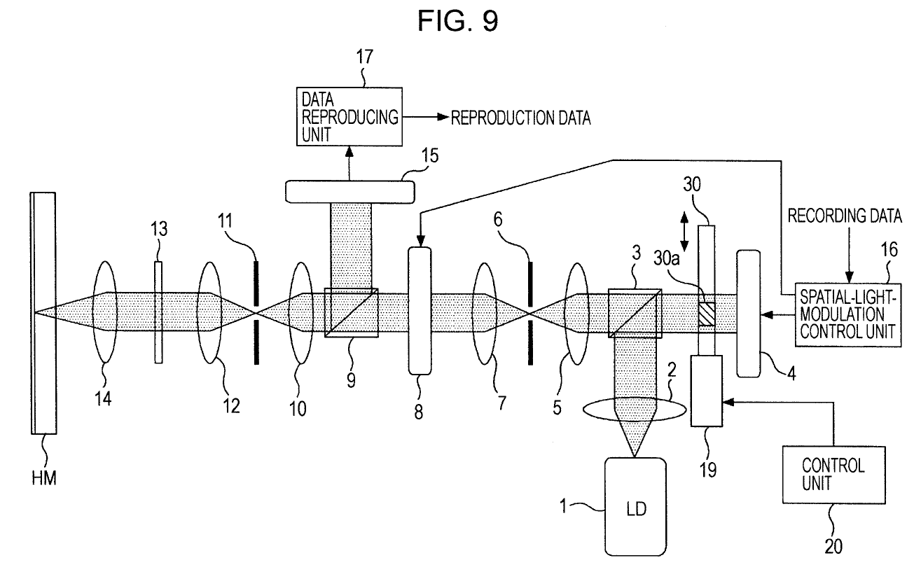

FIG. 9 is a block diagram illustrating the internal configuration of a recording/reproduction device according to the first example of the second embodiment.

In the description below, the already-described components and portions are given the same reference numerals, and descriptions thereof will not be repeated.

In FIG. 9, the configuration of the recording/reproduction device according to the first example of the second embodiment differs from that of the recording/reproduction device shown in FIG. 1 in that a component slidably held by the slide driver 19 is changed from the partial light-attenuating element 18 to a partial polarization-direction controlling element 30.

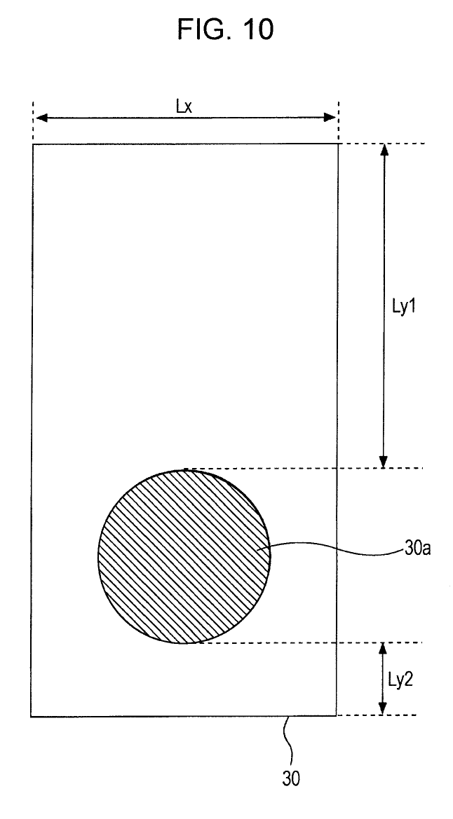

FIG. 10 illustrates the structure of the partial polarization-direction controlling element 30.

As shown in FIG. 10, the partial polarization-direction controlling element 30 is partially provided with a phase shifter (phase plate) 30a. This phase shifter 30a is anisotropic according to the polarization direction and is configured to generate a phase difference π (i.e., a phase difference of λ/2). Specifically, in this case, a half-wave plate is used. Similar to the light-attenuating portion 18a, the phase shifter 30a is given a size that is greater than or equal to the size of the signal-light area A2 and does not to overlap the reference-light area A1. Regarding the size of the partial polarization-direction controlling element 30, the lengths Lx, Ly1, and Ly2 thereof are set in the same manner as in the first embodiment.

An area excluding the area of the phase shifter 30a in the partial polarization-direction controlling element 30 is composed of a material that has satisfactory optical transparency, such as transparent glass or transparent resin, and that does not change the polarization direction of incident light.

In the recording/reproduction device according to the first example of the second embodiment, the partial polarization-direction controlling element 30 having such a structure is slidably driven by the slide driver 19 and the control unit 20 in a similar manner to the first embodiment.

In detail, when recording, the partial polarization-direction controlling element 30 is slidably driven such that the area where the phase shifter 30a is provided is removed from the light path (i.e., such that the area excluding the phase shifter 30a in the partial polarization-direction controlling element 30 covers the reference light). On the other hand, when performing reproduction, the partial polarization-direction controlling element 30 is slidably driven such that the area where the phase shifter 30a is provided is inserted into the light path (i.e., such that the center of the area of the phase shifter 30a is aligned with the light axis).

By sliding the partial polarization-direction controlling element 30 in this manner for the reproduction mode, the light within the beam area of the signal light can be entirely made to enter the phase shifter 30a.

In this case, in the state where the partial polarization-direction controlling element 30 is slidably driven to the insertion position in the light path for the reproduction mode, the phase shifter 30a (i.e., a half-wave plate in this case) is configured such that the direction of a reference optical axis thereof is not in alignment with the polarization direction of incident light (and with a direction orthogonal thereto).

According to the above description with reference to FIG. 1, light emitted from the laser diode 1 serving as a light source enters the phase shifter 30a as y-polarized light via the polarization beam splitter 3. The phase shifter 30a in this case is formed in the partial polarization-direction controlling element 30 such that the direction of the reference optical axis thereof is inclined by an angle θ relative to the y-direction, which is the polarization direction of incident light.

Similar to the light-attenuating portion 18a described above, the phase shifter 30a receives light from the polarization beam splitter 3, and the incident light is made to re-enter the polarization beam splitter 3 via (by being reflected by) the polarization-direction controller 4 (in this case, all the pixels are ON in the signal-light area A2 during reproduction).

In the case where the light travels back and forth through the phase shifter 30a in this manner, the relationship between an angle θ formed between a polarization-direction axis of the incident light on the phase shifter 30a (i.e., the light received from the polarization beam splitter 3) and the reference optical axis of the phase shifter 30a and the transmittance of the polarization beam splitter 3 with respect to the light that re-enters the polarization beam splitter 3 via the ON pixels of the polarization-direction controller 4 is determined based on Jones vector analysis.

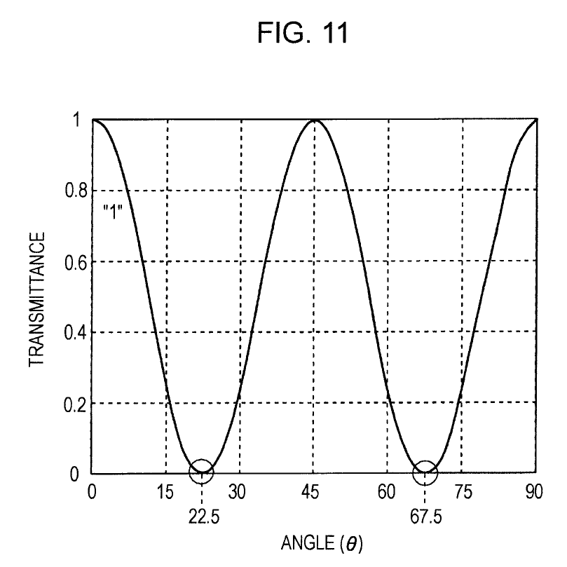

The result is shown in FIG. 11.

In FIG. 11, the relationship is shown with the abscissa indicating the angle θ and the ordinate indicating the transmittance of the polarization beam splitter 3.

The transmittance indicated by the ordinate represents the intensity of light transmitted through the polarization beam splitter 3 when the intensity of light in the ON pixels of the polarization-direction controller 4 is defined as “1”.

As shown in FIG. 11, the transmittance of the polarization beam splitter 3 changes in the form of a sine-wave with an angle θ of 45° being one cycle. Specifically, with a transmittance of 1 corresponding to an angle θ of 0° as the starting point, the transmittance changes in a sine-wave form having a maximum amplitude value when the transmittance is 1, a median amplitude value when the transmittance is 0.5, and a minimum amplitude value when the transmittance is 0. In this case, the transmittance alternately changes in the order 1, 0, 1, . . . in a cycle of an angle θ of 22.5°.

As is apparent from the analytical result in FIG. 11, in the second embodiment, the angle θ is adjusted so that the intensity of light within the beam area of signal light, that is, the intensity of coherent light to be added to a reproduction image during reproduction can be adjusted. In other words, the angle θ may be adjusted so that the intensity of coherent light to be added is attenuated to a predetermined intensity.

As mentioned above, the intensity of coherent light is desirably low as possible within a range that satisfies the condition “the intensity of coherent light when added to a reproduction image is greater than an absolute value of the minimum amplitude value of the reproduction image”. In view of this point, it is apparent that the angle θ in this case be adjusted to near 22.5° or 67.5°.

For confirmation, with the partial polarization-direction controlling element 30 in the inserted state (slid state) for the reproduction mode described above, since the reference light can be transmitted through the area (i.e., the area indicated by Ly2 in FIG. 10) excluding the area of the phase shifter 30a in the partial polarization-direction controlling element 30, the reference light in this case can also be transmitted through the polarization beam splitter 3. Consequently, the reference light can be emitted to the hologram recording medium HM via the objective lens 14 as usual. In other words, a reproduction image can be obtained as usual.

Furthermore, as mentioned above, for the recording mode, the partial polarization-direction controlling element 30 is driven such that the phase shifter 30a is removed from the light path. In other words, the recording operation can be performed as usual by emitting the signal light and the reference light.

Consequently, the recording/reproduction device according to the first example of the second embodiment can perform a normal recording operation as well as obtain a reproduction image while also allowing for an improvement in the reproduction characteristics by attenuating the coherent light.

### 2.2. Second Example (Rotatably-Driving Partial Polarization-Direction Contrilling Element)

In a second example of the second embodiment, the partial polarization-direction controlling element is rotatably driven so as to selectively control the polarization direction of light within the beam area of signal light between the recording and reproduction modes, so that the coherent light can be attenuated at the polarization beam splitter.

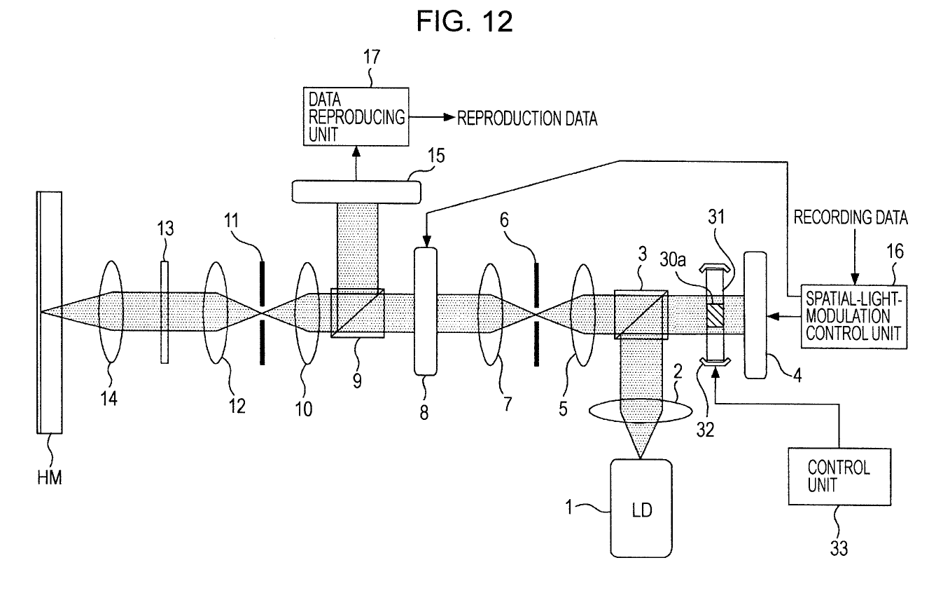

FIG. 12 is a block diagram illustrating the internal configuration of a recording/reproduction device according to the second example of the second embodiment.

The recording/reproduction device according to the second example is provided with a partial polarization-direction controlling element 31 in place of the partial polarization-direction controlling element 30 in the recording/reproduction device according to the first example. Furthermore, in place of the slide driver 19 and the control unit 20, a rotation driver 32 that rotatably holds the partial polarization-direction controlling element 31 and a control unit 33 that controls a rotating operation performed by the rotation driver 32 are provided.

The partial polarization-direction controlling element 31 is provided with a phase shifter 30a having the same size as that in the partial polarization-direction controlling element 30 according to the first example described above. However, the partial polarization-direction controlling element 31 in this case is given limitations different from the limitations on the lengths Lx, Ly1, and Ly2 in the partial polarization-direction controlling element 30 according to the first example. Specifically, in the partial polarization-direction controlling element 31, the length from the center of the area provided with the phase shifter 30a to each end thereof in the x-direction and the length from the center to each end thereof in the y-direction may both be set greater than or equal to the radius of the reference-light area A1 (i.e., the distance from the light axis to the outer circle of the reference-light area A1).

The rotation driver 32 rotatably holds the partial polarization-direction controlling element 31 such that the light within the beam area of signal light is entirely made to enter the phase shifter 30a (i.e., the light is entirely made to enter the phase shifter 30a via the signal-light area A2 of the polarization-direction controller 4). Specifically, the rotation driver 32 rotatably holds the partial polarization-direction controlling element 31 such that the center of the area provided with the phase shifter 30a is aligned with the light axis.

The rotation driver 32 rotatably holding the partial polarization-direction controlling element 31 rotates it in response to a driving signal supplied from the control unit 33.

For example, the rotation driver 32 in this case is equipped with a motor, and the motor is driven in response to a driving signal from the control unit 33, thereby rotating the partial polarization-direction controlling element 31.

The control unit 33 controls the polarity and the pulse width of the driving signal to be supplied to the motor in the rotation driver 32 so as to rotate the partial polarization-direction controlling element 31 by a desired angle in a desired rotational direction.

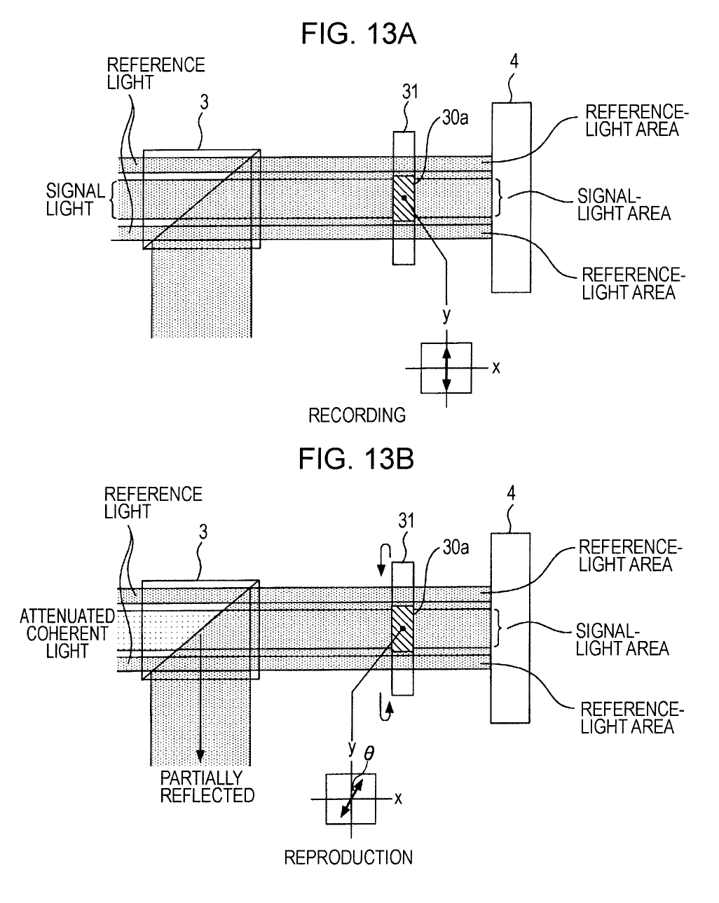

FIGS. 13A and 13B illustrate a light-attenuating technique according to the second example of the second embodiment. Specifically, FIG. 13A corresponds to the recording mode and FIG. 13B corresponds to the reproduction mode. FIGS. 13A and 13B are extracted views of the polarization beam splitter 3, the partial polarization-direction controlling element 31, and the polarization-direction controller 4 shown in FIG. 12. FIG. 13A shows the beam condition and the direction of the reference optical axis of the phase shifter 30a during recording. FIG. 13B shows the beam condition and the direction of the reference optical axis of the phase shifter 30a during reproduction.

As shown in FIGS. 13A and 13B for a comparison between recording and reproduction modes, in the light-attenuating technique according to the second example, the partial polarization-direction controlling element 31 is rotatably driven such that the reference optical axis of the phase shifter 30a is aligned with the polarization-direction axis of the incident light (i.e., y-polarized light which is the first incident light) during recording, and the reference optical axis of the phase shifter 30a is inclined relative to the polarization-direction axis of the incident light by an angle θ during reproduction.

Thus, when recording, the partial polarization-direction controlling element 31 does not control the polarization direction with respect to the light in the beam areas of both signal light and reference light, whereby hologram recording can normally be performed by emitting the signal light and the reference light.

On the other hand, when performing reproduction, the phase shifter 30a is set in the same state as in the first example. Thus, during reproduction, the intensity of light within the beam area of signal light (i.e., the intensity of coherent light) can be adjusted (attenuated) in accordance with the angle θ. Furthermore, with the size setting of the partial polarization-direction controlling element 31, as described above, and the held state of the partial polarization-direction controlling element 31 by the rotation driver 32, polarization-direction control is not performed with respect to light within the beam area of reference light, whereby a reproduction image can be obtained as usual.

Accordingly, in the light-attenuating technique according to the second example, the partial polarization-direction controlling element 31 is rotated so as to give a rotational-angle difference based on an angle θ between the recording mode and the reproduction mode, thereby achieving a state where the reference optical axis of the phase shifter 30a is aligned with the polarization-direction axis of incident light for the recording mode and a state where an angular difference based on an angle θ is given between the direction of the reference optical axis of the phase shifter 30a and the polarization-direction axis of incident light for the reproduction mode.

Consequently, similar to the first example, a recording operation by the emission of signal light and reference light is performed during recording and a reproduction image is obtained by the emission of reference light during reproduction while the reproduction characteristics is improved by attenuating the coherent light.

The control unit 33 in this case is configured to supply a driving signal based on a preset polarity and pulse width to the rotation driver 32 between the recording and reproduction modes so that the partial polarization-direction controlling element 31 is set at a rotational angle that allows the reference optical axis of the phase shifter 30a to be aligned with the polarization-direction axis (y-axis in this case) of incident light during the recording mode or at a rotational angle that allows an angular difference based on an angle θ to be given between the reference optical axis of the phase shifter 30a and the polarization-direction axis of incident light during the reproduction mode, thereby obtaining the rotated states of the partial polarization-direction controlling element 31 shown in FIG. 13A corresponding to the recording mode and FIG. 13B corresponding to the reproduction mode, respectively.

In this case, a positioning member serving as a stopper against the rotating operation may be provided so that the rotated states of the partial polarization-direction controlling element 31 during the recording and reproduction modes respectively shown in FIGS. 13A and 13B can be obtained. The control unit 33 in that case may be configured to at least control the direction in which the partial polarization-direction controlling element 31 is rotated by the rotation driver 32.

### 3. THIRD EMBODIMENT (EXAMPLE THAT USES PARTIAL POLARIZATION-DIRECTION CONTROLLER)

In a third embodiment, a partial polarization-direction controller partially having an element that can variably control the polarization direction in response to a driving signal is used. The partial polarization-direction controller performs partial polarization-direction control on incident light, and the polarization beam splitter performs partial light attenuation so as to attenuate the coherent light.

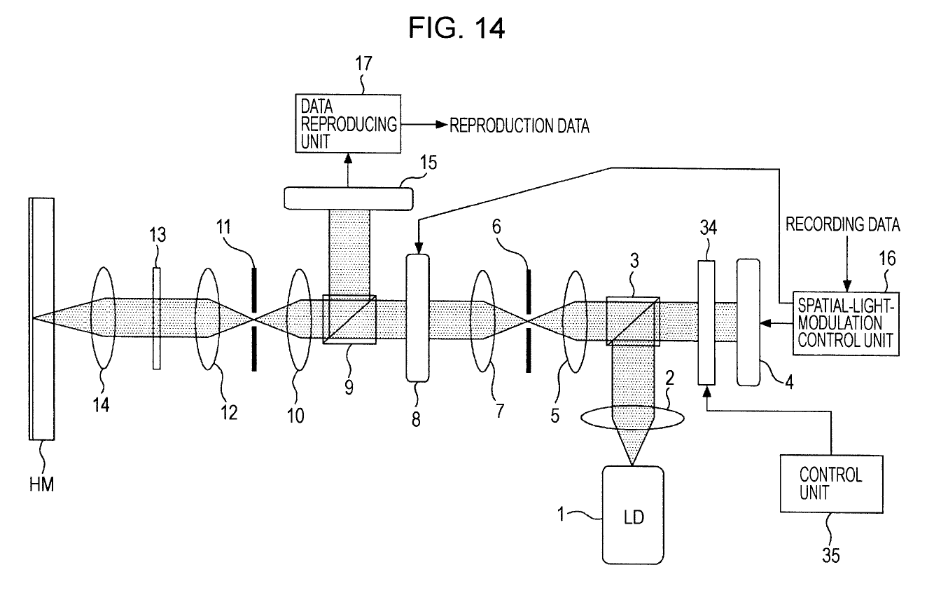

FIG. 14 is a block diagram illustrating the internal configuration of a recording/reproduction device according to the third embodiment.

Referring to FIG. 14, as compared with the recording/reproduction device according to the first embodiment (FIG. 1), the slide driver 19 and the control unit 20 are omitted in the recording/reproduction device according to the third embodiment, the partial light-attenuating element 18 is replaced by a partial polarization-direction controller 34, and a control unit 35 that controls the driving of the partial polarization-direction controller 34 is provided.

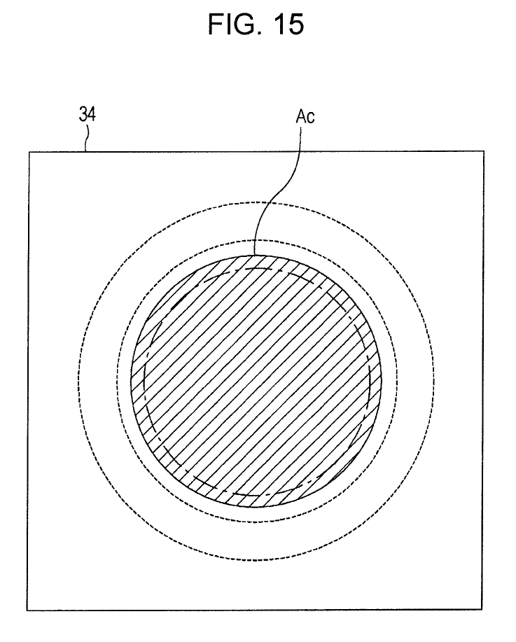

Referring to FIG. 15, the partial polarization-direction controller 34 has a control area Ac and an area excluding the control area Ac. Like the light-attenuating portion 18a and the phase shifter 30a, the control area Ac is given a size that is greater than or equal to the size of the signal-light area A2 (denoted by a dot-dashed line) and does not overlap the reference-light area A1 (denoted by dashed lines).

The overall size of the partial polarization-direction controller 34 is set such that the length from the center of the control area Ac to each end thereof in the x-direction and the length from the center to each end thereof in the y-direction are both greater than or equal to the radius of the reference-light area A1.

The partial polarization-direction controller 34 is configured to generate a phase difference π (perform phase modulation by a phase modulation amount π) in the control area Ac between ON and OFF states of a driving signal from the control unit 35. The area excluding the control area Ac is composed of a material that does not change the polarization direction of incident light, such as transparent glass or transparent resin.

In detail, in the partial polarization-direction controller 34, the control area Ac is formed of a liquid crystal element. The thickness of the liquid crystal is adjusted so as to generate a phase difference by π (λ/2) between the OFF state of the driving signal (when the liquid crystal element is in a horizontal orientation) and the ON state of the driving signal (when the liquid crystal element is in a vertical orientation). This structure is the same as the structure of the phase modulator 8 described above with reference to FIG. 4.

In the partial polarization-direction controller 34 that generates a phase difference n in accordance with the ON and OFF states of the driving signal, the control area Ac, when the driving signal is ON, has a characteristic similar to that of a half-wave plate.

In view of this point, in the recording/reproduction device according to the third embodiment, the partial polarization-direction controller 34 is inserted in the optical system such that the reference optical axis of the control area Ac is inclined relative to the polarization-direction axis of incident light (i.e., the y-axis in this case) by an angle θ. In this case, the partial polarization-direction controller 34 is inserted in the optical system such that the entire light within the beam area of signal light (i.e., the entire light passing through the signal-light area A2 of the polarization-direction controller 4) is made to enter the control area Ac. Specifically, the center of the partial polarization-direction controller 34 (which is also the center of the control area Ac) is aligned with the light axis of a laser beam.

The driving signal for the control area Ac is OFF for recording, whereas the driving signal is ON for reproduction. The driving of the partial polarization-direction controller 34 (i.e., the control area Ac) is controlled by the control unit 35 shown in FIG. 14.

By controlling the driving for the recording and reproduction modes in this manner, the polarization direction of the incident light on the partial polarization-direction controller 34 is not changed during recording, thereby allowing for a normal recording operation by the emission of signal light and reference light.

On the other hand, when performing reproduction, the polarization direction of light within the beam area of signal light is controlled in the control area Ac so that the polarization direction of the light that re-enters the polarization beam splitter 3 is changed in accordance with an angle θ (the relationship between the angle θ and the transmittance of the polarization beam splitter 3 in this case is the same as that shown in FIG. 11), thereby attenuating the coherent light added to the reproduction image.

Furthermore, with the size setting of the partial polarization-direction controller 34, as described above, and the inserted state of the partial polarization-direction controller 34 in the light path, polarization-direction control is not performed by the partial polarization-direction controller 34 with respect to light within the beam area of reference light, whereby a reproduction image can be obtained as usual.

Consequently, the recording/reproduction device according to the third embodiment can perform a normal recording operation by the emission of signal light and reference light during recording and can obtain a reproduction image by the emission of reference light during reproduction while also allowing for an improvement in the reproduction characteristics by attenuating the coherent light.

### 4. MODIFICATIONS

Although the embodiments of the present invention have been described above, the invention is not limited to these specific embodiments.

For example, although a configuration in which the partial light-attenuating element 18 or the partial polarization-direction controlling element 30 is slidably driven is described above as a specific configuration example for moving the light-attenuating portion 18a or the phase shifter 30a into and away from the light path, the light-attenuating portion 18a or the phase shifter 30a may be moved into and away from the light path by using an alternative driving technique other than the sliding technique, such as providing a driver that flips the partial light-attenuating element 18 or the partial polarization-direction controlling element 30 (or 31) upward or downward from the light path.

Furthermore, although the intensity modulation unit that performs intensity modulation for generating signal light and reference light is constituted by a combination of a polarization-direction control type spatial light modulator (i.e., the polarization-direction controller 4) and a polarization beam splitter in the above description, a single spatial light modulator functioning as an intensity modulator that can perform intensity modulation by itself, such as a reflective liquid crystal panel or a Digital Micromirror Device (DMD) (registered trademark), may alternatively be used without having to combine it with a polarization beam splitter.

As an example of such a configuration, the reflective liquid crystal panel or DMD may be provided in place of the polarization-direction controller 4 shown in FIG. 1 and the polarization beam splitter 3 may be used as a half mirror (in this case, the laser beam emitted via the collimator lens 2 is x-polarized light instead of y-polarized light).

If a liquid crystal panel, for example, is used as a single spatial light modulator that can perform intensity modulation by itself, the intensity of coherent light can be adjusted to a certain extent. In other words, coherent light with an intensity lower than an intensity “1” can be generated.

However, in such an intensity modulator, such as a liquid crystal panel, which can variably perform light intensity modulation with respect to individual pixels, it is difficult to adjust the intensity of coherent light to an extent that a reproduction image with a satisfactory contrast can be ensured.

In view of the diffraction efficiency of a hologram (e.g., 10⁻⁴), the intensity of coherent light to be added is preferably reduced to, for example, about 0.1% ( 1/1000) when modulation with respect to an intensity of “1” is performed. However, under the present conditions, it is extremely difficult to stably set the intensity to about 1/1000 in a configuration in which light intensity modulation is variably performed with respect to individual pixels. For this reason, in the related art, the intensity (amplitude) of coherent light is set significantly greater than the amplitude of a reproduction image, such as “1” or “0.1”, leading to deterioration in reproduction characteristics.

In light of this, an intensity modulator, such as the aforementioned liquid crystal panel, which can variably perform light intensity modulation with respect to individual pixels is used. In this case, the attenuation of the coherent light based on the light-attenuating technique according to an embodiment of the present invention is significantly effective when it is possible to generate coherent light attenuated to a certain extent relative to the intensity “1”. In other words, in the embodiment of the present invention, a configuration that allows for the attenuation of coherent light generated on the basis of the intensity modulation performed by the intensity modulation unit is provided. Accordingly, the intensity of coherent light can be stably reduced to a lower intensity. In consequence, the contrast of a reproduction image can be enhanced, thereby ultimately improving the reproduction characteristics.

As a spatial light modulator, a transmissive type (such as a transmissive liquid crystal panel) may be used instead of a reflective type. For example, when a transmissive spatial light modulator is used as a single spatial light modulator that can perform intensity modulation by itself, the configuration of the optical system may be changed such that, for example, the polarization beam splitter 3 is omitted and a laser beam is made to enter the transmissive spatial light modulator via the laser diode 1 and the collimator lens 2 in that order. Alternatively, when a polarization-direction control type transmissive spatial light modulator is to be used, the laser diode 1, the collimator lens 2, the spatial light modulator, and the polarization beam splitter 3 may be arranged in that order.

When a transmissive spatial light modulator is used in this manner, the partial light-attenuating element 18, the partial polarization-direction controlling element 30 (or 31), or the partial polarization-direction controller 34 may be disposed such that the components can be arranged in, for example, the following order: the laser diode 1, the collimator lens 2, the partial light-attenuating element 18, and the spatial light modulator, or in the following order: the laser diode 1, the collimator lens 2, the partial polarization-direction controlling element 30 (or 31) or the partial polarization-direction controller 34, the spatial light modulator, and the polarization beam splitter 3.

With respect to the light-attenuating unit according to an embodiment of the present invention, although the partial light-attenuating element 18, the partial polarization-direction controlling element 30 (or 31), or the partial polarization-direction controller 34 is interposed between the polarization beam splitter 3 and the polarization-direction controller 4 in the above description, the position thereof is not limited to that described above.

For example, these components may be disposed in the vicinity of the phase modulator 8 (that is, in the vicinity of the real image plane of the polarization-direction controller 4), such as between the phase modulator 8 and the relay lens 7 or between the phase modulator 8 and the polarization beam splitter 9.

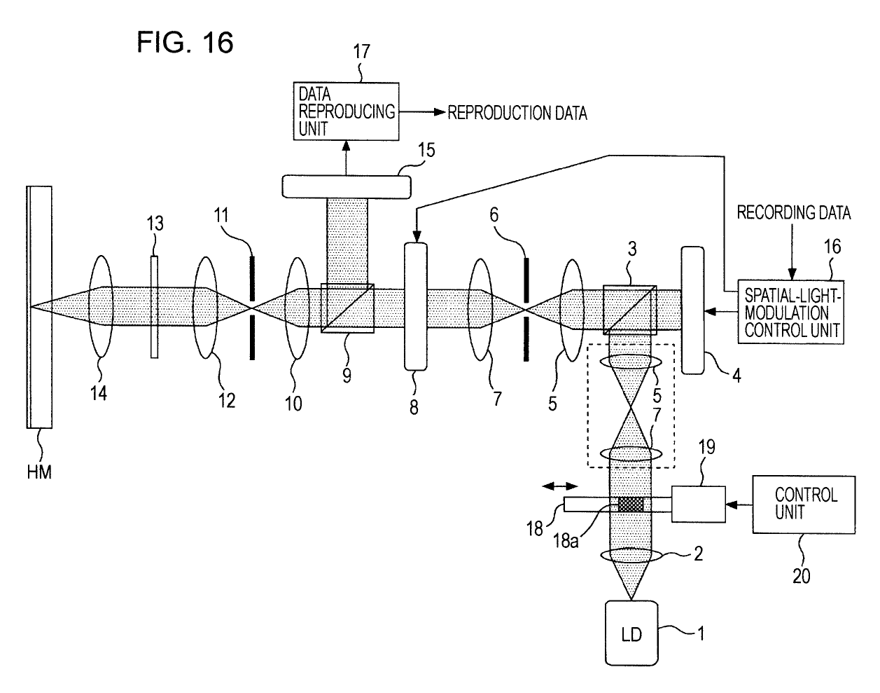

Alternatively, as shown in FIG. 16, an additional relay lens system may be provided to form a new real image plane of the polarization-direction controller 4, thereby allowing for increased variations in the insertion position of the partial light-attenuating element 18, the partial polarization-direction controlling element 30 (or 31), or the partial polarization-direction controller 34.

FIG. 16 illustrates a configuration example in which another relay lens system is added to the configuration according to the first embodiment (FIG. 1).

Specifically, a relay lens system surrounded by a dashed line and constituted by a relay lens 5 and a relay lens 7 arranged in that order is interposed between the polarization beam splitter 3 and the collimator lens 2, such that a real image plane of the polarization-direction controller 4 is formed between the relay lens 7 and the collimator lens 2. In this example, the partial light-attenuating element 18 is inserted into a position corresponding to the real image plane formed as the result of adding the relay lens system.

Although this example is directed to a case where the partial light-attenuating element 18 is inserted, the partial polarization-direction controlling element 30 (or 31) or the partial polarization-direction controller 34 can be similarly inserted in the same position.

However, when the insertion position is set as shown in FIG. 16 or in the vicinity of the phase modulator 8 as described above, the light does not travel back and forth through the partial light-attenuating element 18, the partial polarization-direction controlling element 30 (or 31), or the partial polarization-direction controller 34, unlike the above embodiments.

Therefore, the transmittance determination factor of a light-attenuating material, which causes the intensity of coherent light to be added to be reduced to a predetermined intensity, or the angle θ between the reference optical axis and the polarization-direction axis of the incident light is set in view of the fact that the attenuation or the polarization-direction control is performed only once with respect to incident light.

For confirmation, it may be necessary to properly guide the reproduction image to the image sensor 15 during reproduction. Therefore, it is obvious that the light-attenuating unit according to an embodiment of the present invention be set at an insertion position that at least prevents the reproduction image from being attenuated (i.e., a position between the polarization beam splitter 3, which is where a plane of the reproduction image to be extracted by the image sensor 15 is formed, and the collimator lens 2 in the case of FIG. 1).

In order to properly attenuate the coherent light, the insertion position of the partial light-attenuating element 18, the partial polarization-direction controlling element 30 (or 31), and the partial polarization-direction controller 34 is preferably close to the real image plane of the polarization-direction controller 4 (or a single spatial light modulator that can perform intensity modulation by itself) as possible. Furthermore, it is most preferable that an additional relay lens system be provided as shown in FIG. 16 and be inserted in a position corresponding to a real image plane of the polarization-direction controller 4 (or a single spatial light modulator that can perform intensity modulation by itself).

Although the recording/reproduction device described above is configured to be used with a reflective hologram recording medium HM, the recording/reproduction device can also be configured to be used with a transmissive hologram recording medium not having a reflective film.

When a transmissive hologram recording medium is used, the reproduction image penetrates the hologram recording medium so as to be output to the opposite side thereof depending on the emission of reference light during reproduction.

In view of this point, the recording/reproduction device in this case is provided with an additional objective lens at a position opposite the hologram recording medium relative to the light source, and the reproduction image is made to enter the objective lens. The optical system is made to guide the reproduction image obtained through this objective lens to the image sensor 15. In this case, the quarter-wave plate 13 for extracting the reproduction image obtained as reflected light from the recording medium can be omitted as it may not be necessary.

For confirmation, when the recording/reproduction device is used with a transmissive hologram recording medium, the basic operation of the device for performing hologram recording and reproduction is the same as that for the reflective type. Specifically, when recording, an interference pattern is formed on the hologram recording medium by emitting signal light and reference light thereto so as to record data on the hologram recording medium. When performing reproduction, reference light and coherent light are emitted to the hologram recording medium so that reproduction based on the “coherent addition method” is performed.

When the recording/reproduction device is used with such a transmissive hologram recording medium, the light-attenuating unit according to an embodiment of the present invention can be inserted between the relay lens 12 and the objective lens 14 (the quarter-wave plate 13 in this case can be omitted). In this case, the partial light-attenuating element 18, the partial polarization-direction controlling element 30 or 31, or the partial polarization-direction controller 34 in the light-attenuating unit is most preferably inserted in a position corresponding to a real image plane formed by the relay lens system that includes the aforementioned relay lens 12.

Although a ring-shaped reference-light area A1 is provided so as to surround the circular signal-light area A2 in the above description, the shapes of the signal-light area and the reference-light area are not limited to a circular shape and a ring shape. As another alternative, the reference-light area may be disposed on the inside, and the signal-light area may be disposed on the outside.

The partial light-attenuating element 18, the partial polarization-direction controlling element 30 or 31, and the partial polarization-direction controller 34 may each be formed such that, depending on the shapes of and the positional relationship between the signal-light area and the reference-light area set in the spatial light modulator for generating reference light and signal light, the area excluding the area that receives light incident on the reference-light area of the spatial light modulator or light passing through the reference-light area and including the area that receives light incident on the signal-light area of the spatial light modulator or light passing through the signal-light area is at least formed of a light-attenuating material, a phase shifter, or an element capable of performing variable polarization-direction control.

In the second and third embodiments described above, the area of the phase shifter 30a in the partial polarization-direction controlling element 30 or 31 and the control area Ac in the partial polarization-direction controller 34 are set so as to partially cover the gap area A3. Thus, even when the light intensity in the gap area A3 is modulated towards “0” by the spatial light modulator, a portion of the light intensity is not modulated to “0” due to the controlling of the polarization direction by the phase shifter 30a or the control area Ac.

Since the size of the phase shifter 30a and the control area Ac is set so as not to overlap the reference-light area A1, a buffer area where the light intensity is “0” is formed with respect to the reference light. However, in actuality, if light in a region of the gap area A3 that partially overlaps the phase shifter 30a or the control area Ac acts as noise light against the reference light, the phase shifter 30a and the control area Ac may be reduced in size. In this case, the size of the phase shifter 30a and the control area Ac is set so as to satisfy the condition in which the size is greater than or equal to the size of the signal-light area A2.

Although the above description is directed only to an example where the attenuation of coherent light is performed in the recording/reproduction device that can perform both recording and reproduction, the attenuation of coherent light may be performed in a reproduction-only device that performs only reproduction.

In the case of a reproduction-only device, the attenuation of coherent light may continuously be performed by the light-attenuating unit in a section including the beam area of signal light but excluding the beam area of reference light. Specifically, the partial light attenuation by the light-attenuating portion 18a or the attenuation by the polarization beam splitter in response to the partial polarization-direction control by the phase shifter 30a may continuously be performed. In view of this point, the slide driver 19, the control unit 20, the rotation driver 32, and the control unit 33 can be omitted in a reproduction-only device. In addition, in the case of a reproduction-only device, the partial polarization-direction control variably performed only for the reproduction mode may be unnecessary, meaning that the partial polarization-direction controller 34 can be omitted.

In view of this point, in the case of a reproduction-only device, the partial light-attenuating element 18 may be simply inserted such that the light-attenuating portion 18a covers the entire beam area of signal light, or the combination of the partial polarization-direction controlling element 30 (or 31) and the polarization beam splitter may be inserted (in this case, the partial polarization-direction controlling element may be inserted such that the area with the phase shifter 30a covers the entire beam area of signal light and that the reference optical axis of the phase shifter 30a is inclined relative to the polarization-direction axis of incident light by an angle θ).

The present application contains subject matter related to that disclosed in Japanese Priority Patent Application JP 2008-231362 filed in the Japan Patent Office on Sep. 9, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A reproduction device comprising:
a light-emitting unit that emits reference light and coherent light onto a hologram recording medium on which data is recorded by an interference pattern of signal light and the reference light, the coherent light being generated so as to have uniform light intensity and uniform phase; and
a light-attenuating unit that attenuates the light intensity of the coherent light.

2. The reproduction device according to claim 1, wherein the light-emitting unit includes
a light source,
an intensity modulation unit including a spatial light modulator having set therein a signal-light area serving as an area for generating the signal light and a reference-light area serving as an area for generating the reference light and performing spatial light modulation on incident light with respect to each pixel, the intensity modulation unit being configured to perform spatial light intensity modulation on the incident light,
a phase modulator having set therein the signal-light area and the reference-light area and performing spatial light phase modulation on incident light with respect to each pixel,
an optical system that guides light emitted from the light source to the hologram recording medium via the intensity modulation unit, the phase modulator, and an objective lens, and
a modulation control unit configured to control driving of pixels within the reference-light area of the spatial light modulator and the phase modulator so as to generate the reference light and also configured to control driving of pixels within the signal-light area of the spatial light modulator and the phase modulator so as to generate the coherent light having uniform light intensity and uniform phase.

3. The reproduction device according to claim 2, wherein the light-attenuating unit includes a partial light-attenuating element in which an area thereof excluding an area that receives light incident on the reference-light area of the spatial light modulator or light passing through the reference-light area and including an area that receives light incident on the signal-light area of the spatial light modulator or light passing through the signal-light area is composed of a light-attenuating material.

4. The reproduction device according to claim 3, wherein the reproduction device also has a function of performing recording on the hologram recording medium, and
wherein the light-attenuating unit includes
the partial light-attenuating element,
a driver that drives the partial light-attenuating element such that the area composed of the light-attenuating material in the partial light-attenuating element is moved into and away from a light path, and
a drive control unit that controls the driver so as to drive the partial light-attenuating element such that the light incident on the signal-light area or the light passing through the signal-light area is attenuated by the area composed of the light-attenuating material only during reproduction.

5. The reproduction device according to claim 2, wherein the light-attenuating unit includes
a partial polarization-direction controlling element in which an area thereof excluding an area that receives light incident on the reference-light area of the spatial light modulator or light passing through the reference-light area and including an area that receives light incident on the signal-light area of the spatial light modulator or light passing through the signal-light area is formed of a phase shifter that is anisotropic and generates a phase difference π, and
a polarization beam splitter inserted in the optical system so as to be positioned between the partial polarization-direction controlling element and the objective lens.

6. The reproduction device according to claim 5, wherein the reproduction device also has a function of performing recording on the hologram recording medium, and
wherein the light-attenuating unit includes
the partial polarization-direction controlling element,
a driver that moves the partial polarization-direction controlling element,
the polarization beam splitter, and
a drive control unit that controls the driver so as to move the partial polarization-direction controlling element such that the light passing through the signal-light area is attenuated at the polarization beam splitter only during reproduction due to polarization-direction control performed on incident light by the area formed of the phase shifter.

7. The reproduction device according to claim 6, wherein the driver is configured to drive the partial polarization-direction controlling element such that the area formed of the phase shifter in the partial polarization-direction controlling element is moved into and away from a light path, and
wherein, for recording, the drive control unit controls the driver so as to drive the partial polarization-direction controlling element such that the area formed of the phase shifter is positioned outside the light path, and, for reproduction, the drive control unit controls the driver so as to drive the partial polarization-direction controlling element such that the light incident on the signal-light area or the light passing through the signal-light area is made to enter the area formed of the phase shifter.

8. The reproduction device according to claim 6, wherein the partial polarization-direction controlling element is disposed in the optical system such that the light incident on the signal-light area or the light passing through the signal-light area is made to enter the area formed of the phase shifter,
wherein the driver is a rotation driver that rotatably drives the partial polarization-direction controlling element, and
wherein the drive control unit controls the driver so as to rotationally drive the partial polarization-direction controlling element such that the partial polarization-direction controlling element is given a predetermined rotational-angle difference between a recording mode and a reproduction mode.

9. The reproduction device according to claim 5, wherein the phase shifter is a half-wave plate.

10. The reproduction device according to claim 2, wherein the reproduction device also has a function of performing recording on the hologram recording medium,
wherein the light-attenuating unit includes
a partial polarization-direction controller in which a target area thereof excluding an area that receives light incident on the reference-light area of the spatial light modulator or light passing through the reference-light area and including an area that receives light incident on the signal-light area of the spatial light modulator or light passing through the signal-light area is capable of variably controlling the polarization direction of incident light in accordance with a driving signal,
a drive control unit that controls a polarization-direction control operation of the partial polarization-direction controller by supplying the driving signal to the partial polarization-direction controller, and
a polarization beam splitter inserted in the optical system so as to be positioned between the partial polarization-direction controller and the objective lens, and
wherein the drive control unit controls the partial polarization-direction controller such that the polarization direction of light incident on the target area is changed by a predetermined angle of less than 90° only during reproduction.

11. The reproduction device according to claim 2, wherein the spatial light modulator included in the intensity modulation unit is equipped with a ferroelectric liquid crystal element that changes the polarization direction of the incident light with respect to each pixel, and
wherein the intensity modulation unit further includes a polarization beam splitter inserted in a position that receives light passing through the spatial light modulator.

12. The reproduction device according to claim 2, wherein the spatial light modulator included in the intensity modulation unit functions as an intensity modulator that is capable of performing the spatial light intensity modulation on the incident light with respect to each pixel.

13. The reproduction device according to one of claims 11 and 12, wherein the light-attenuating unit is inserted in a position corresponding to a real image plane of the spatial light modulator.

14. A reproduction method for performing reproduction by emitting reference light and coherent light onto a hologram recording medium on which data is recorded by an interference pattern of signal light and the reference light, the coherent light being generated so as to have uniform light intensity and uniform phase, the method comprising the step of:
performing the reproduction in a state where the light intensity of the coherent light is attenuated.
